(19) United States
(12) Patent Application Publication
(10) Pub. No.: US 2022/0157342 A1
(43) Pub. Date: May 19, 2022

(54) Video Enhancements

(71) Applicant: Facebook Technologies, LLC, Menlo Park, CA (US)

(72) Inventors: Kiryl KLIUSHKIN, Mountain View, CA (US); Eric Liu GAN, San Francisco, CA (US); Tali ZVI, San Carlos, CA (US); Hannes Luc Herman VERLINDE, Ruislip (GB); Michael SLATER, Nottingham (GB); Franklin HO, New York, NY (US); Andrew Pitcher THOMPSON, Tarrytown, NY (US); Michelle Jia-Ying CHEUNG, Cupertino, CA (US); Gil CARMEL, San Francisco, CA (US); Stefan Alexandru JELER, Los Angeles, CA (US); Somayan CHAKRABARTI, Brooklyn, NY (US); Sung Kyu Robin KIM, Pleasanton, CA (US); Duylinh NGUYEN, Union City, CA (US); Katherine Anne ZHU, Atlanta, GA (US); Anaelisa ABURTO, Los Angeles, CA (US); Anthony GRISEY, San Francisco, CA (US)

(21) Appl. No.: 17/590,333

(22) Filed: Feb. 1, 2022

Related U.S. Application Data
(60) Provisional application No. 63/240,577, filed on Sep. 3, 2021.
(60) Provisional application No. 63/240,574, filed on Sep. 3, 2021.
(60) Provisional application No. 63/238,876, filed on Aug. 31, 2021.
(60) Provisional application No. 63/238,889, filed on Aug. 31, 2021.
(60) Provisional application No. 63/238,916, filed on Aug. 31, 2021.
(60) Provisional application No. 63/219,526, filed on Jul. 8, 2021.

(51) Int. Cl. G11B 27/036; G11B 27/06; G06V 20/40; G11B 27/10; G06T 19/00

(52) U.S. Cl. CPC G11B 27/036; G11B 27/06; G06T 19/006; G11B 27/10; G06V 20/48

(57) ABSTRACT

Aspects of the present disclosure are directed to three-dimensional (3D) video calls where at least some participants are assigned a position in a virtual 3D space. Additional aspects of the present disclosure are directed to an automated effects engine that can A) convert a source still image into a flythrough video; B) produce a transform video that replaces portions of a source video with an alternate visual effect; and/or C) produce a switch video that automatically matches frames between multiple source videos and stiches together the videos at the match points. Further aspects of the present disclosure are directed to a platform for the creation and deployment of automatic video effects that respond to lyric content and lyric timing values for audio associated with a video and/or that respond to beat types and beat timing values for audio associated with a video.

### CROSS REFERENCE TO RELATED APPLICATIONS

This application claims priority to U.S. Provisional Application Nos. 63/219,526 filed Jul. 8, 2021, 63/238,876 filed Aug. 31, 2021, 63/238,889 filed Aug. 31, 2021, 63/238,916 filed Aug. 31, 2021, and 63/240,577 filed Sep. 3, 2021. Each patent application listed above is incorporated herein by reference in their entireties.

### SUMMARY

Aspects of the present disclosure are directed to three-dimensional (3D) video calls where at least some participants are assigned a position in a virtual 3D space. Participants in the video call can be displayed according to their virtual position, e.g., by showing the participants' video feeds in a 3D environment, by arranging the participants' video feeds on their 2D displays according to their virtual positions, or by adding an effect to groups of participants' video feeds, the groups identified based on their virtual positions. Further, various effects can be applied to the video feeds by evaluating rules that take the virtual positions as parameters and modify the video feeds, such as to change participant visual appearance in their video feed, grant participants various abilities (e.g., mute/unmute participants, video call access controls, defining new rules, access a chat thread, etc.), change participant audio output or how the participant perceives the audio of others, etc.

Aspects of the present disclosure are directed to an automated effects engine that can convert a source still image into a flythrough video. A flythrough video transitions between various locations in a 3D space into which portions of the source image are mapped. The automated effects engine can accomplish this by receiving an image, applying a machine learning model trained to segment the image into foreground entities and a background entity, using a machine learning model to fill in gaps in the background entity, mapping the entities into a 3D space, defining a path through the 3D space to focus on each of the foreground entities, and recording the flythrough video by recording by a virtual camera traversing through the 3D space along the defined path.

Aspects of the present disclosure are directed to an automated effects engine that can produce a transform video that replaces portions of a source video with an alternate visual effect. The automated effects engine can accomplish this by receiving a source video and a selection of an element of the video (e.g., an article of clothing, a person or part of a person, a background area, an object, etc.), receiving an alternate visual effect (e.g., another video, an image, a color, a pattern, etc.), applying a machine learning model trained to identify the selected element throughout the source video, and replacing the selected element throughout the source video with the alternate visual effect.

Aspects of the present disclosure are directed to an automated effects engine that can produce a switch video that automatically matches frames between multiple source videos and stiches together the videos at the match points. The automated effects engine can accomplish this by determining where a breakpoint frame, in each of two or more provided source videos, best match a frame in another of the source videos. This can include applying a machine learning model trained to match frames and/or determining a position/pose of entities (people, objects, etc.) depicted in the breakpoint frame that match corresponding entities' position/pose in the frames of the other source videos. The automated effects engine can splice together the source videos according to where these matchups occur. In various implementations, the location of the breakpoint in the source videos can be A) pre-determined so each splice is the same length (e.g., 1 or 2 seconds), B) a user selected point, C) based on a contextual factor such as music associated with the source videos, or D) by the automated effects engine dynamically finding frames that match between the source videos.

Aspects of the present disclosure are directed to a platform for the creation and deployment of automatic video effects that respond to lyric content and lyric timing values for audio associated with a video. In various implementations, creators can define effects that perform various actions in the rendering of a video based on a number defined lyric content and lyric timing values. In some cases, these values can be defined at the lyric phrase and lyric word level, such as for the content of lyrics, when they start, their duration, or how far along playback is for particular lyrics in the timing of the video. Effects can be defined to perform actions such as automatically showing the lyrics according to their timing, in relation to various tracked objects or body parts in a video, or showing current lyric phrases or words in response to a user action (such as a clap). In various implementations, the effects can further use beat timing values, as discussed in related U.S. Provisional Patent Application, titled Beat Reactive Video Effects, filed herewith, and with Attorney Docket No. 3589-0088DP01, which is incorporated herein by reference in its entirety.

Aspects of the present disclosure are directed to a platform for the creation and deployment of automatic video effects that respond to beat types and beat timing values for audio associated with a video. In various implementations, creators can define effects that perform various actions in the rendering of a video based on a number defined beat types and beat timing values. In some cases, these values can be defined for all beats in a song and/or for individual beat types such as strong beats, down beats, phrase beats, or two bar beats. For each beat, variables can be set that specify the type of beat, a wave pattern for the beat, when the beat starts, the beat's duration, or how far along playback is into the beat. Effects can be defined to perform actions based on the beat data such as automated zooming, blurring, strobing, orientation changes, scene mirroring, scene multiplication, playback speed manipulation, etc. In various implementations, the effects can further use other inputs such as lyric content and timing values, as discussed in related U.S. Provisional Patent Application, titled Lyric Reactive Video Effects, filed herewith, and with Attorney Docket No. 3589-0087DP01, which is incorporated herein by reference in its entirety.

### BACKGROUND

Video conferencing has become a major way peoples connect. From work calls to virtual happy hours, webinars to online theater, people feel more connected when they can see other participants, bringing them closer to an in-person experience. However, video calls remain a pale imitation of face-to-face interactions. Real-world interactions rely on a variety of positional cues, such as where people are standing, moving into breakout groups, taking someone aside, etc. to effectively organize communications. Further, user roles in a real-world conversation are often defined by the participant's physical location. For example, a presenter is typically given a podium or central position, allowing others to easily view the presenter while giving the presenter access to controls such as a connection for presenting from an electronic device or access to an audio/video setup.

There are many different video and image editing systems allowing users to create sophisticated editing and compilation effects. With the right equipment, software, and commands, a user can apply effects to produce nearly any imaginable visual result. However, video editing typically requires complicated editing software that can be very expensive, difficult to use, and, without significant training, is unapproachable for the typical user. This can be particularly true when a user wants to add multimodal effects (i.e., effects that are based on and/or control both the audio and visual aspects of a video). Accessing the content and timing from both the audio and visual aspects can be challenging and getting the correct timing for effects can be difficult and may produce choppy results when applied by non-expert users.

### BRIEF DESCRIPTION OF THE DRAWINGS

FIG. 1 is an example of video call participants organized on a two dimensional surface according to assigned virtual locations.

FIG. 2 is an example of video call participants organized in an artificial environment according to assigned virtual locations.

FIG. 3 is an example of video call participants organized into groups defined based on assigned virtual locations.

FIG. 4 is an example of video call participants with effects applied according to rules evaluated based on assigned virtual locations.

FIG. 5 is a flow diagram illustrating a process used in some implementations for administering a three dimensional scene in a video call.

FIGS. 6-13 illustrate an example of using an image to create a flythrough video.

FIG. 14 is a flow diagram illustrating a process used in some implementations for converting an image to a flythrough video.

FIG. 15 illustrates an example of the results of segmenting an image into foreground and background elements.

FIGS. 16-19 illustrate a first example of creating a transform video that replaces a background portion of a video with an alternate visual effect.

FIGS. 20-23 illustrate a second example of creating a transform video that replaces an article of clothing portion of a video with an alternate visual effect.

FIG. 24 is a flow diagram illustrating a process used in some implementations for creating a transform video that replaces portions of a video with an alternate visual effect.

FIG. 25 is a conceptual diagram illustrating an example of the process for generating a switch video by automatically matching frames between multiple source videos.

FIGS. 26-31 illustrate an example of a switch video by showing multiple matched frames of the switch video.

FIG. 32 is a flow diagram illustrating a process used in some implementations for generating a switch video by stitching together portions of multiple source videos at automatically matched frames.

FIG. 33 is a system diagram of an audio effects system.

FIG. 34 is an example of lyric phrase data for the lyrics of an audio track.

FIG. 35 illustrates examples of videos rendered with audio effects based on lyric content and timing.

FIG. 36 is a flow diagram illustrating a process used in some implementations for the deployment of automatic video effects that respond to lyric content and lyric timing values for audio associated with a video.

FIG. 37 is a system diagram of an audio effects system.

FIG. 38 is an example of lyric phrase data for the lyrics of an audio track.

FIG. 39 illustrates examples of a video rendered with an audio effect based on beat timing.

FIG. 40 is a flow diagram illustrating a process used in some implementations for the deployment of automatic video effects that respond to beat type and timing values for audio associated with a video.

FIG. 41 is a block diagram illustrating an overview of devices on which some implementations can operate.

FIG. 42 is a block diagram illustrating an overview of an environment in which some implementations can operate.

### DETAILED DESCRIPTION

Current video calls systems do not provide a sense of presence afforded by both in-person and VR communications, due to their lack of spatial design. Often participants in a video call are arranged alphabetically or according to an order in which they joined the video call. A three-dimensional video call system can allow users to setup a “scene” in a video call, by breaking people out of their standard 2D square and assigning them a virtual position in a 3D space. This scene can position the video feeds of the participants according to their virtual position and/or apply visual and audio effects that are controlled, at least in part, according to participants' virtual positions. In various implementations, participants can self-select a virtual location, can be assigned a virtual location according to other parameters such as team or workgroup membership or other assigned roles, can be assigned a virtual location by a video call administrator, can be assigned a virtual location based on a determined real-world location of the participant, can be given a location based on an affinity to other video call participants (e.g., frequency of messaging between the participants, similarity of characteristics, etc.), can be re-assigned a virtual location based on where the video call participant was in a pervious call, etc.

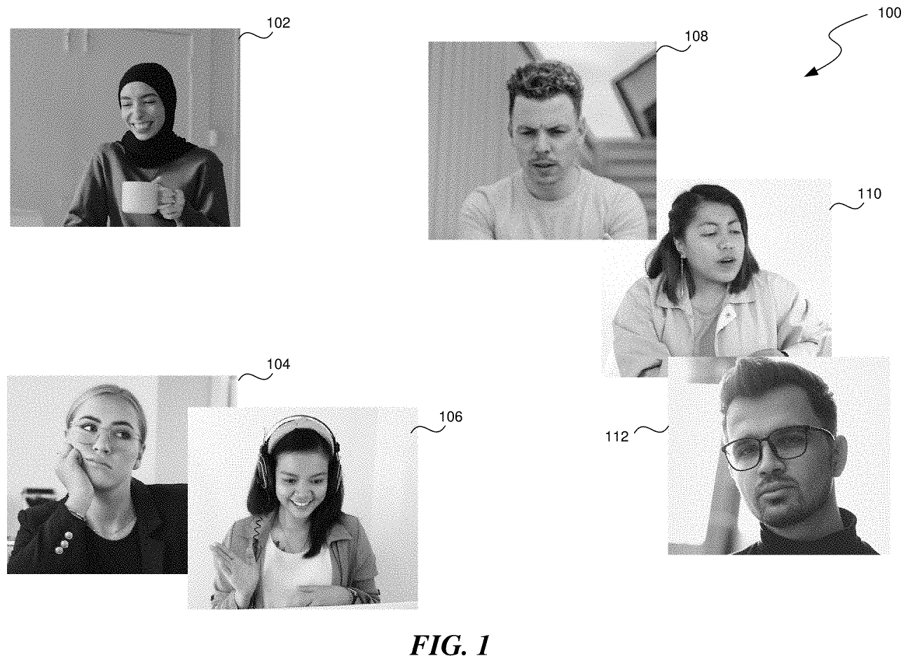

In some implementations, the three-dimensional video call system can organize video call participants spatially as output on a flat display of a user. For example, the three-dimensional video call system can put participants' video feeds into a grid or shown them as free-form panels according to where they are in the virtual space; the three-dimensional video call system can show a top-down view of the virtual space with the participants video feeds placed in the virtual space; each other user's video feed can be sized according to how distant that user is from the viewing user in the virtual space; etc. FIG. 1 is an example 100 of video call participants organized on a two dimensional surface according to assigned virtual locations. In example 100, video streams 102-112 are arranged on a 2D surface according to the assigned virtual locations of the corresponding participants.

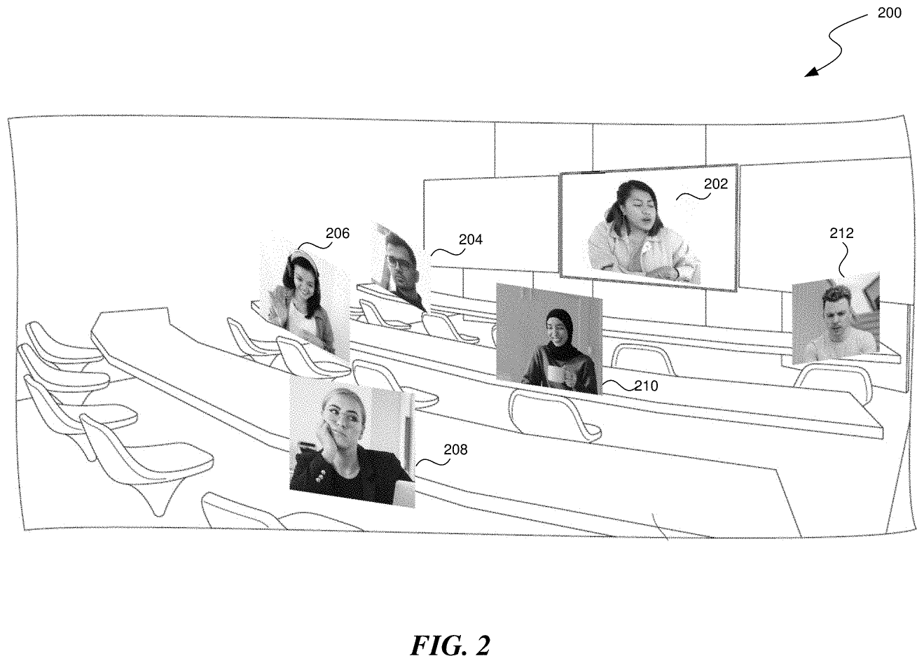

In some implementations, the three-dimensional video call system can illustrate the video call to show the virtual space as an artificial environment, with participants' video feeds spatially organized in the 3D space. For example, the artificial environment can be a conference room, a recreation of a physical space in which one or more of the participants are located, a presentation or meeting hall, a fanciful environment, etc. Each video call participant can have a view into the artificial environment, e.g., from a common vantage point or a vantage point positioned at their assigned virtual location, and the video feeds of the other call participants can be located according to each participant's virtual location. FIG. 2 is an example 200 of video call participants organized in an artificial environment according to assigned virtual locations. The video stream 202 has been placed on a presentation panel due to the corresponding participant having been assigned to a presenter virtual location. Each of the other video streams 204-212 have been assigned seats in a virtual conference room according to their assigned virtual locations. The participants can select new seats, causing the corresponding video stream to be displayed in that new seat.

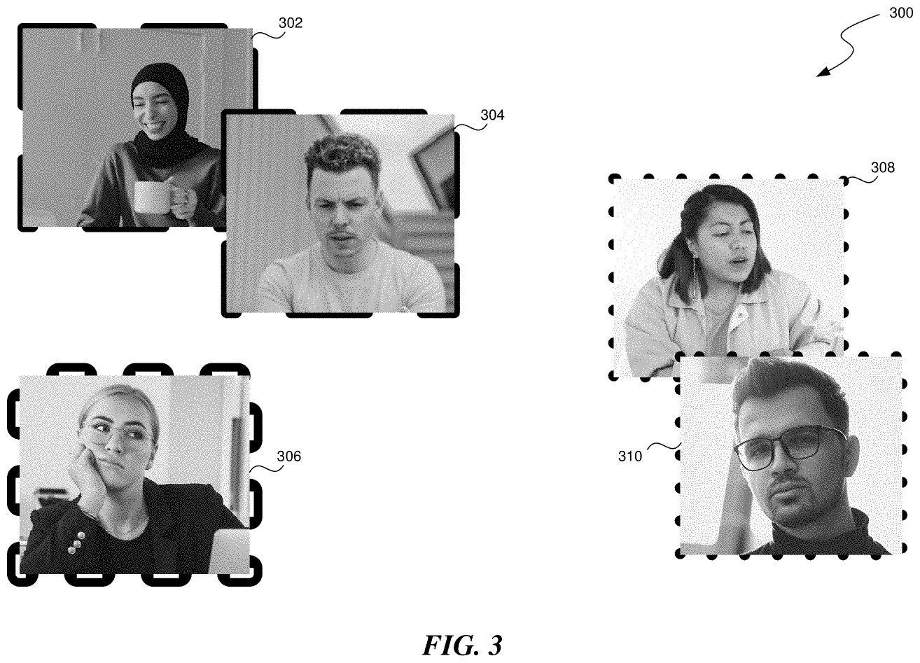

In some cases, the three-dimensional video call system can assign video call participants into spatial groups, and give them corresponding group effects, based on their virtual locations. Various clustering procedures can be used to assign group designations, such as by grouping all participants who are no more than a threshold distance from a group central point; creating groups where no participant in the group is more than a threshold distance from at least one other group member; setting groups by defining a group size (either as a spatial distance or as a number of group participants) and selecting groups that match the group size; etc. The three-dimensional video call system can apply group effects to a group according to rules or by group participants, such as by adding a matching colored border to the video feeds of all participants in the same group; applying an AR effect to group participant video feeds (e.g., a text overlay showing the group's discussion topic, matching AR hats, etc.); dimming or muting the sound for feeds not in the same group; etc. FIG. 3 is an example 300 of video call participants organized into groups defined based on assigned virtual locations. In example 300, the participants for video streams 302 and 304 have been assigned to a first group based on their virtual locations being within a threshold distance of a first group center point; the participant for video stream 306 has been assigned to a second group based on her virtual location being within a threshold distance of a second group center point; and the participants for video streams 308 and 310 have been assigned to a third group based on their virtual locations being within a threshold distance of a third group center point. A first group border effect has been applied to the video feeds 302 and 304 based on their first group membership; a second group border effect has been applied to the video feed 306 based on her second group membership; and a third group border effect has been applied to the video feeds 308 and 310 based on their third group membership.

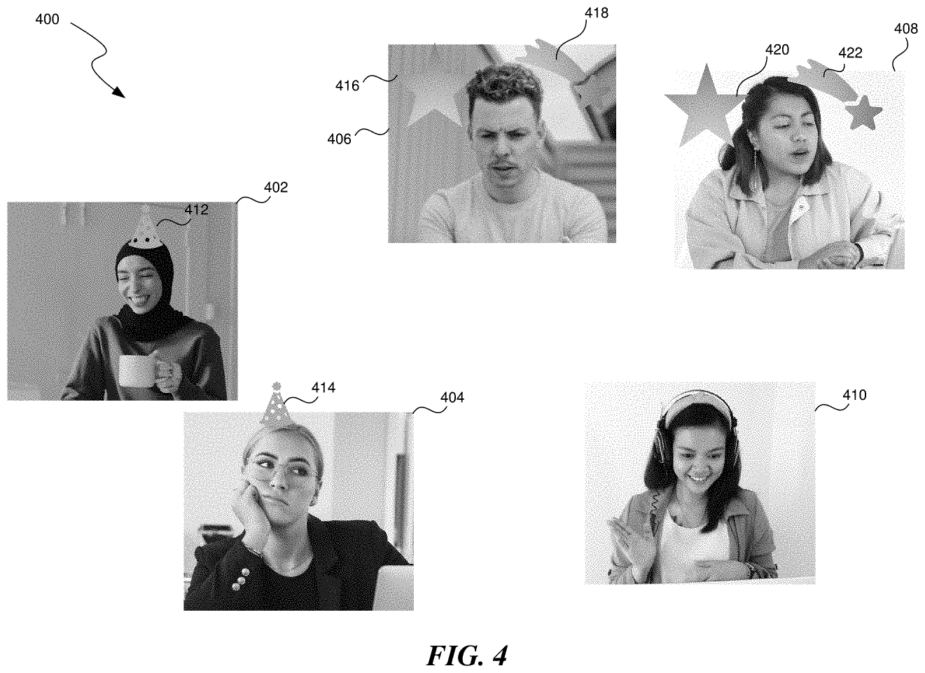

In various implementations, the three-dimensional video call system can evaluate a variety of rules that apply effects to video call participants according to the participant's virtual location. For example, when a viewing participant is hearing audio from another video call participant, the three-dimensional video call system can diminish the audio or apply an echo to it commensurate with the distance. As another example, the three-dimensional video call system can have assigned a particular area in virtual space, and when a participant's virtual location is within that virtual space, the three-dimensional video call system applies a corresponding effect (e.g., wearing a crown, having cat whiskers, etc.). As yet another example, when a participant has a particular virtual location (e.g., standing at a virtual podium), the participant can be given certain controls, such as the ability to mute other video call participants, kick others out of the video call, etc. There is no limit on the type or variety of effects or controls that can be applied; the three-dimensional video call system can apply any conceivable effect or control rule takes virtual location or spatial values as at last one of the triggering parameters or parameter to enable the effect or control. FIG. 4 is an example 400 of video call participants with effects applied according to rules evaluated based on assigned virtual locations. In example 400, users calling in from an office building have been assigned to virtual locations to the left whereas people calling in from home are assigned virtual locations on the right and user locations are further assigned in the virtual space according to their longitude on earth. Thus, video feeds 402 and 404 for participants calling in from a central office are positioned further to the left, video feeds 406 and 408 for participants calling in from Canada are positioned further toward the top, and video feed 410 corresponding to a user calling in from her home in Brazil is positioned lower and to the right. In example 400, one of the office workers is having a birthday, so a first rule has been defined for all office participants to have birthday hat effects, i.e., birthday hats AR effects 412 and 414. Also in example 400, someone noticed there is currently a meteor shower over the northern hemisphere and has setup a second rule having participants in the norther hemisphere that can currently see the meteor shower have star AR effects 416-422.

In various implementations, different participants of a video call can have different views, e.g., spatially organized 2D views of a scene, a scene shown as a spatially organized 3D views into an artificial environment, participants assigned spatial groups with corresponding group effects, spatial based rules applied or not, etc. In some implementations, these different output configurations can be set by a video call administrator, by individual participant settings, according to participant computing system type or capabilities, etc.

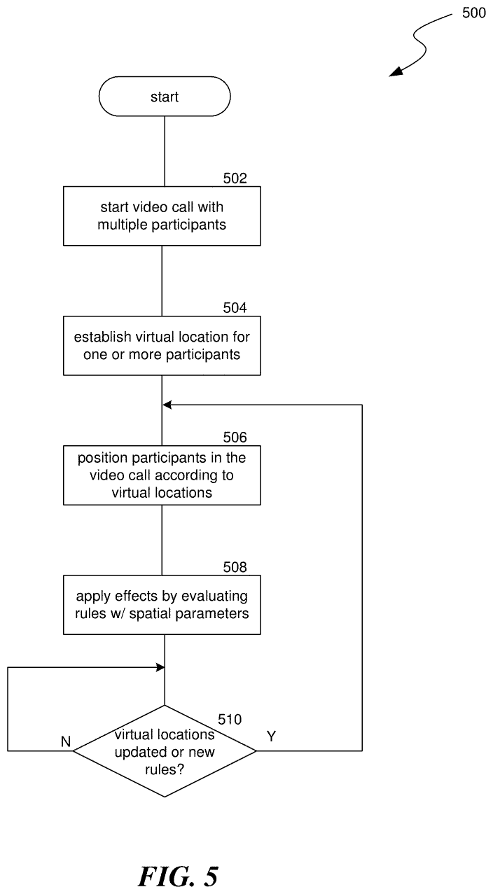

FIG. 5 is a flow diagram illustrating a process 500 used in some implementations for administering a three dimensional scene in a video call. In various implementations, process 500 can be performed as a client-side or server-side process for the video call. For example, as a server-side process, process 500 can assign virtual locations to call participants and apply spatial effects to each video feed before serving that feed to the other call participants. As a client-side process, process 500 can coordinate with other versions of process 500 for other call participants to have agreed upon virtual locations for each call participant and process 500 can have a set of rules that it applies with these virtual locations for the various call participant video feeds. Such a client-side implementation can facilitate having different rules applied to video feeds for each receiving user, so different participants can see different effects applied.

At block 502, process 500 can start a video call with multiple participants. The video call can include each participant sending an audio and/or video feed. In various implementations, the video call can be administered by a central platform or can be distributed with each client managing the sending and receiving of call data. In various implementations, the video call can use a variety of video/audio encoding, encryption, password, etc. technologies. In some implementations, video calls can be initiated through a calendaring system where participants can organize the call through invites with a video call link that each participant is to activate at a designated time.

At block 504, process 500 can establish virtual locations for one or more participants of the video call. In various implementations, a participant can self-select a virtual location, can be assigned a virtual location according to other parameters such as team or workgroup membership or other assigned roles, can be assigned a virtual location by a video call administrator, can be assigned a virtual location based on a determined real-world location of the participant, can be given a location based on an affinity to other video call participants (e.g., frequency of messaging between the participants, similarity of characteristics, etc.), can be assigned a virtual location based on the participant's real-world location (e.g., within a room, within a building, or on a larger scale such as by city or country), can be re-assigned a virtual location based on where the video call participant was in a pervious call, etc. In various implementations, a participant, call administrator, or automated system can update a participant's virtual location throughout the call. For example, a call participant can join the call using artificial reality device capable of tracking the participant's real-world movements, and as the user moves about, her virtual location can be updated accordingly.

At block 506, process 500 can position participants' video feeds in a display of the video call according to the participants' virtual locations. In some implementations, this can include arranging the participants video feeds on a 2D grid or free-form area according to the participants' virtual distances. An example of such a free-form 2D display is discussed above in relation to FIG. 1. In other implementations, this can include showing the participants video feeds in a 2D or 3D artificial environment, such as in a virtual conference room. An example of such an artificial environment with video feeds is discussed above in relation to FIG. 2. In yet further implementations, process 500 can define groups for video call participants according to the participants' virtual locations. Various clustering procedures can be used to assign group designations, such as by grouping all participants who are no more than a threshold distance from a group central point; creating groups where no participant in the group is more than a threshold distance from at least one other group member; setting groups by defining a group size (either as a spatial distance or as a number of group participants) and selecting groups that match the group size; etc. Once groups are defined, process 500 can apply effects or controls to an entire group. An example of such group designations and corresponding group effects is discussed above in relation to FIG. 3.

At block 508, process 500 can apply effects to one or more of the participants' video feeds by evaluating rules with virtual location parameters. In various implementations, rules can be created for a particular video call or be applied across a set of video calls (e.g., all video calls for the same company or team have the same effects). In various implementations, the rules can be defined by an administrator for the video call, an administrator for the video call platform, a third-party effect creator, a video call participant or organizer, etc. These rules can take spatial parameters (e.g., the virtual location of one or more video call participants, relative distance between multiple participants, which spatial grouping the user is in, the virtual location in relation to other objects or aspects of an artificial environment, etc.) In some cases, the rules can take additional parameters available to the video call system, such as user assigned roles, participant characteristics (e.g., gender, hair color, clothing, etc.), results of modeling of the participant (e.g., whether the participant is smiling or sticking our her tongue, body posture, etc.), third party data (e.g., whether it's currently raining, time of day, aspects from a participant's calendar application, etc.), or any other available information.

In some cases, different rules can be agreed upon among the client systems in the video call, such as a rule controlling who the current presenter is; while in other cases rules can be only evaluated for certain systems (e.g., if one participant shares a party hat rule for the boss, but doesn't want a potential investor on the call to see the effect). In some cases, when a rule evaluates to true based on the received parameters, it can apply a role to a user (e.g., some areas in the virtual space may be muted, a user at a virtual podium can be made the current presenter, a user at a virtual switchboard can be a current call administrator, etc.); it can grant a user certain powers (e.g., controls for muting other users, kicking out other users, controlling a presentation deck, an ability to post to a chat thread for the video call, the ability to define new rules, etc.); it can apply an audio effect (e.g., only people within the same designated breakout room area can hear each other or audio volume is adjusted according to the virtual distance between users, etc.), or it can apply a visual effect (e.g., give everyone at the virtual bar a crown, display everyone in the front row of the virtual conference room with a yellow hue, etc.) An example of such visual effects based on virtual position is discussed above in relation to FIG. 4.

At block 510, process 500 can determine whether a video call participant's virtual location has been updated or whether a new rule has been defined. For example, a participant may select a new location, may be assigned a different role with roles corresponding to locations, etc. As another example, in some implementations, video call effect rules may be added (or removed) while the video call is in progress, such as by call participants or a call administrator. If participant virtual locations change or rules are added or removed, process 500 can return to block 506. Otherwise, process 500 can remain at block 510 until either of these conditions occur or the video call ends.

An automated effects engine can receive a source image and use it to automatically produce a flythrough video. A flythrough video converts the source image into a 3D space with the video showing transitions between various locations in that 3D space. The automated effects engine can define a 3D space based on the source image. In some cases, the automated effects engine can define the 3D space by applying a machine learning model to the source image that converts it into a 3D image (i.e., an image with parallax so it looks like a window, appearing different depending on the viewing angle). In other cases, the automated effects engine can apply a machine learning model that identifies foreground entities and segments them out from the background; applies another machine learning model that fills in the background behind the segmented out foreground entities; and places the background and foreground entities into a 3D space. The automated effects engine can also define a path through the 3D space, such as by one of: connecting a starting point to each of the foreground entities; using a default path; or receiving user instructions to define the path. Finally, the automated effects engine can record the flythrough video with a virtual camera flying through the 3D space along the defined path.

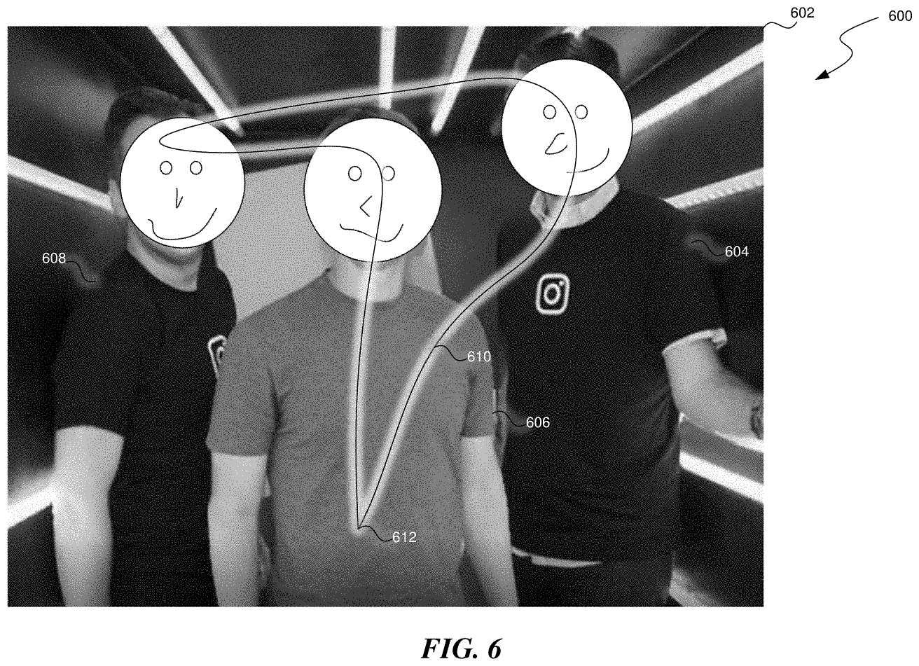

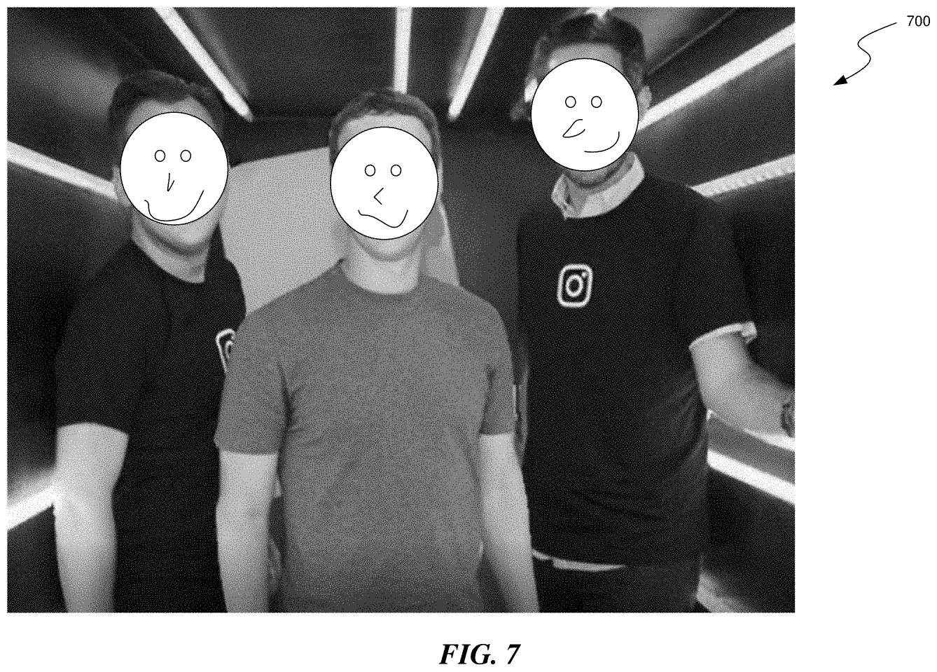

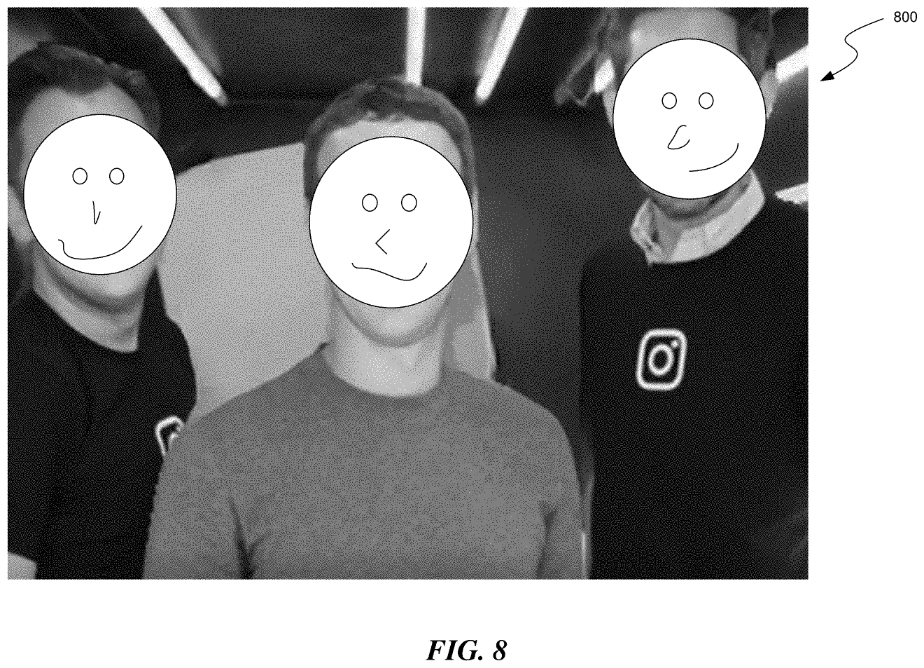

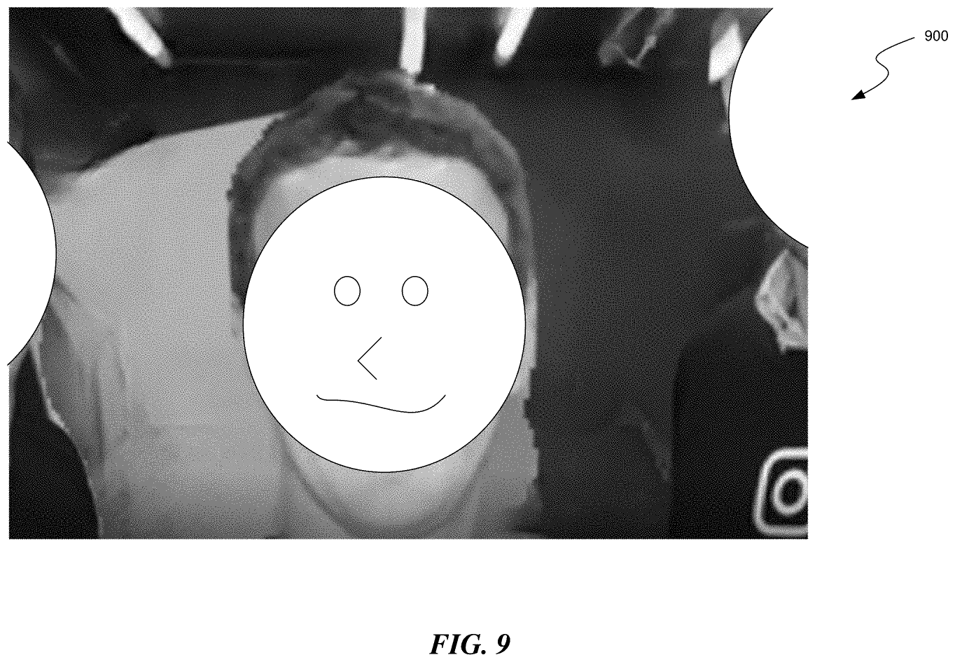

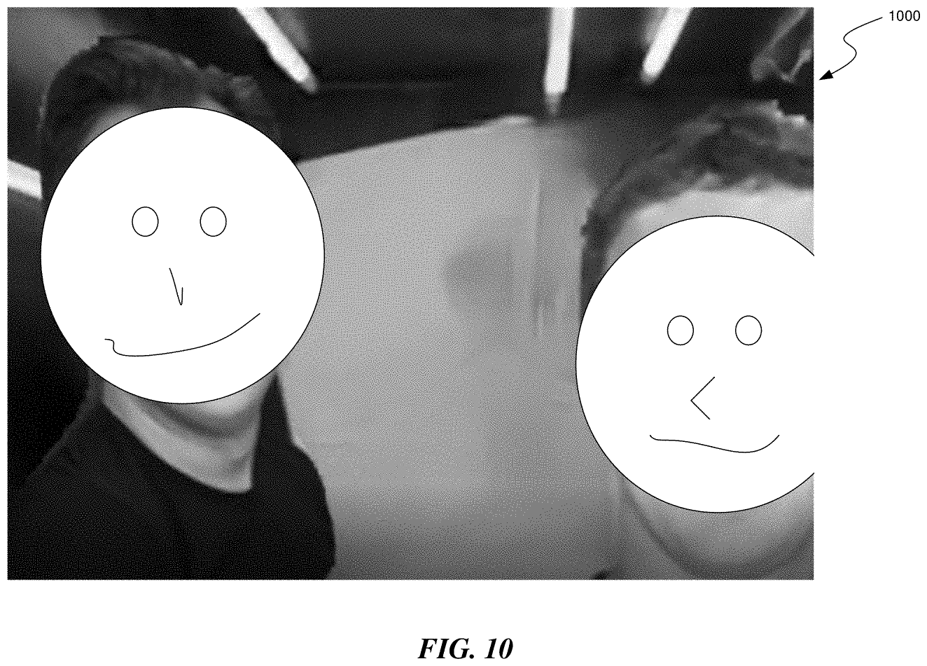

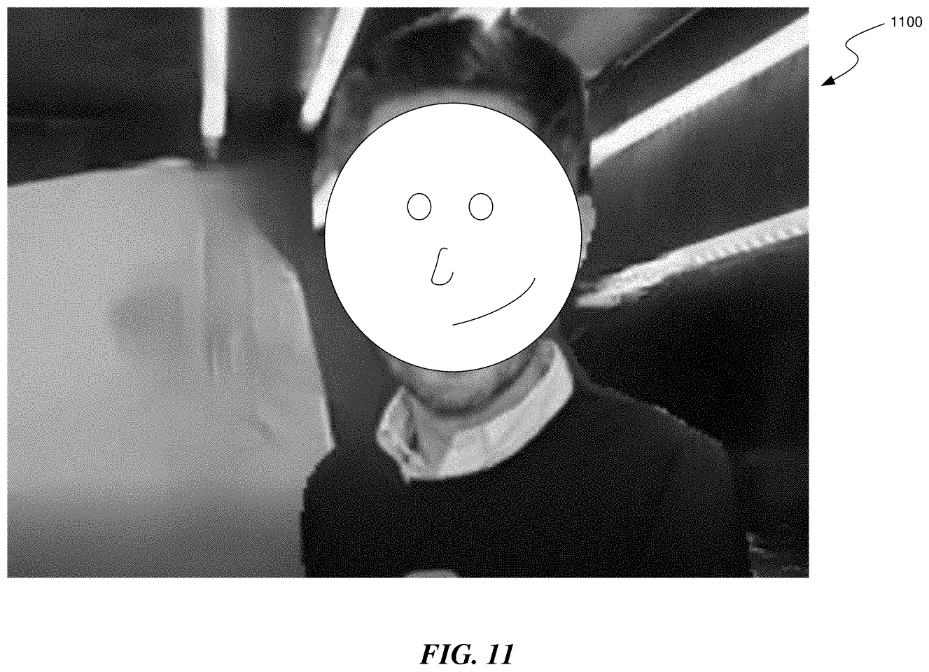

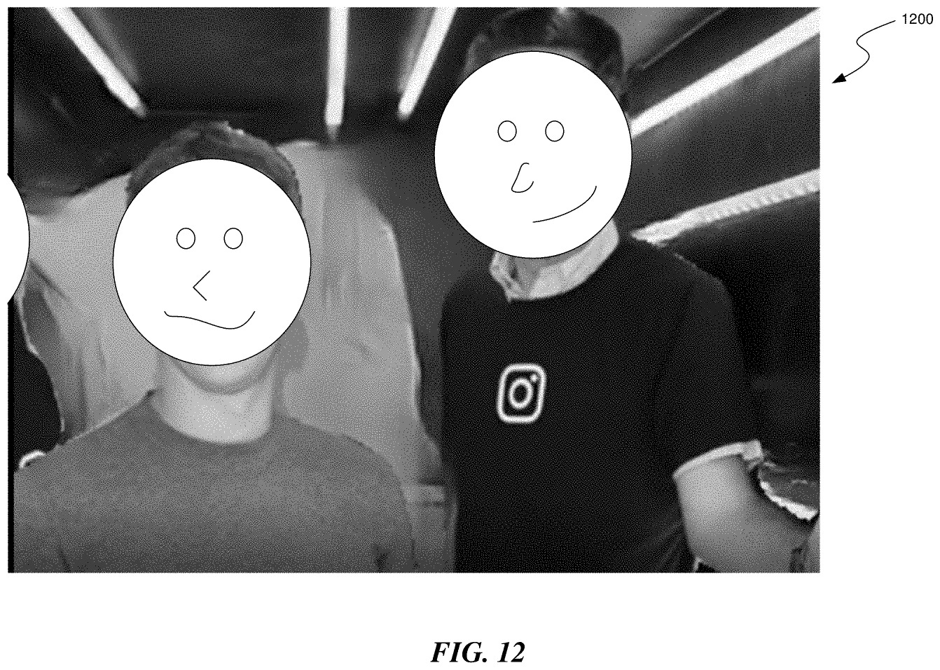

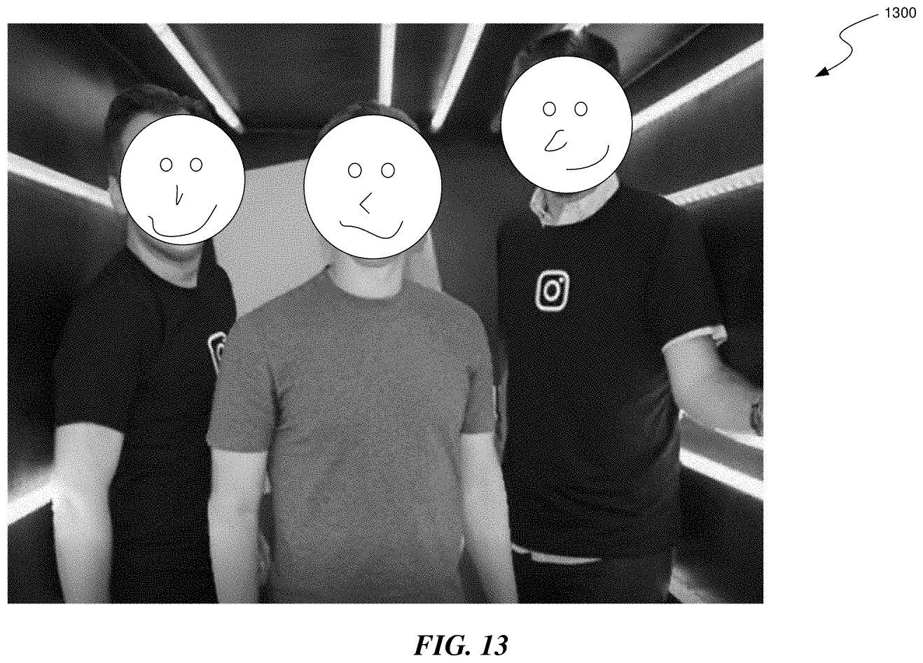

FIGS. 6-13 illustrate an example of using an image to create a flythrough video. The example begins at 600 in FIG. 6, where source image 602 has been segmented into three foreground entities 604, 606, and 608 corresponding to each of the depicted people and a background entity for the rest of the image. The background entity has been auto-filled such that the areas behind the foreground entities 604, 606, and 608 are filled in. The foreground entities and the background entity have been mapped into a 3D space and a flythrough path 610 has been defined for a virtual camera through the 3D space, starting at position 612 and continuing such that the path will cause a virtual camera to focus on the face of each of the foreground entities 604, 606, and 608, before returning to the starting position 612. The example continues through 700-1300, in FIGS. 7-13, illustrating some selected frames from the resulting flythrough video where the virtual camera has traversed path 610. Because the virtual camera is traversing through a 3D space, the perspective on the foreground entities and their relative position in relation to the background changes, giving a parallax effect to the flythrough video.

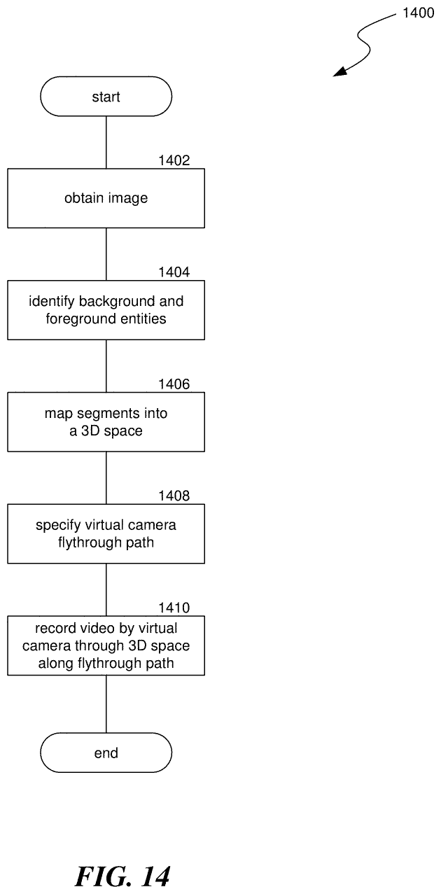

FIG. 14 is a flow diagram illustrating a process 1400 used in some implementations for converting an image to a flythrough video. At block 1402, process 1400 can obtain an image for the flythrough video. For example, a user can supply the image or a URL from which process 1400 can download the image. In some cases, the image can be a traditional flat image. In other cases, the image can be a 3D image, in which case blocks 1404 and 1406 can be skipped. In some cases, the image can be from a video where a user specifies the place in the video from which to take the image.

At block 1404, process 1400 can identify background and foreground entities. The foreground entities can be entity types identified by a machine learning model (e.g., people, animals, specified object types, etc.) and/or can be based on a focus of the image (e.g., entities in focus can be part of the foreground while out-of-focus parts can be the background). The background entity can the parts of the image that remain that are not identified as part of a foreground entity. Process 1400 can mask out these entities to divide the source image into segments. Process 1400 can also fill in portions of the background where foreground entities were removed by applying another machine learning model trained for image completion.

At block 1406, process 1400 can map the segments of the source image into a 3D space. In some implementations, this can include adding the foreground entity segments to be a set amount in front of the background entity segment. In other cases, the mapping can include applying a machine learning model trained to determine depth information for parts of the source image and mapping the segments according to the determined depth information for that segment. For example, if a person is depicted in the source image and the average of the depth information for the pixels showing that person are four feet from the camera, the segment for that person can be mapped to be four feet from a front edge of the 3D space; while if the average of the depth information for the pixels showing the background entity are 25 feet from the camera, the segment for the background can be mapped to be 25 feet from a front edge of the 3D space.

At block 1408, process 1400 can specify a virtual camera flythrough path through the 3D space. In some implementations, the flythrough path can be a default path or a path (e.g., user selected) from multiple available pre-defined paths. In other implementations, the flythrough path can be specified so as to focus on each of the foreground entity segments. Where a foreground segment is above a threshold size (e.g., a size above the capture area of a virtual camera), an identified feature of the foreground entity can be set as a point for the path. For example, a foreground entity that is a person may take up too much area in the source image for a virtual camera to focus on it completely, thus the flythrough path can be set to focus on an identified face of this user. In some implementations, a user can manually set a flythrough path or process 1400 can suggest a flythrough path to the user and the user can adjust it as desired.

At block 1410, process 1400 can record a video by having a virtual camera traverse through the 3D space along the specified flythrough path. Process 1400 can have the virtual camera adjust to focus on the closest identified foreground entity as it traverses the flythrough path. The resulting video can be provided as the flythrough video.

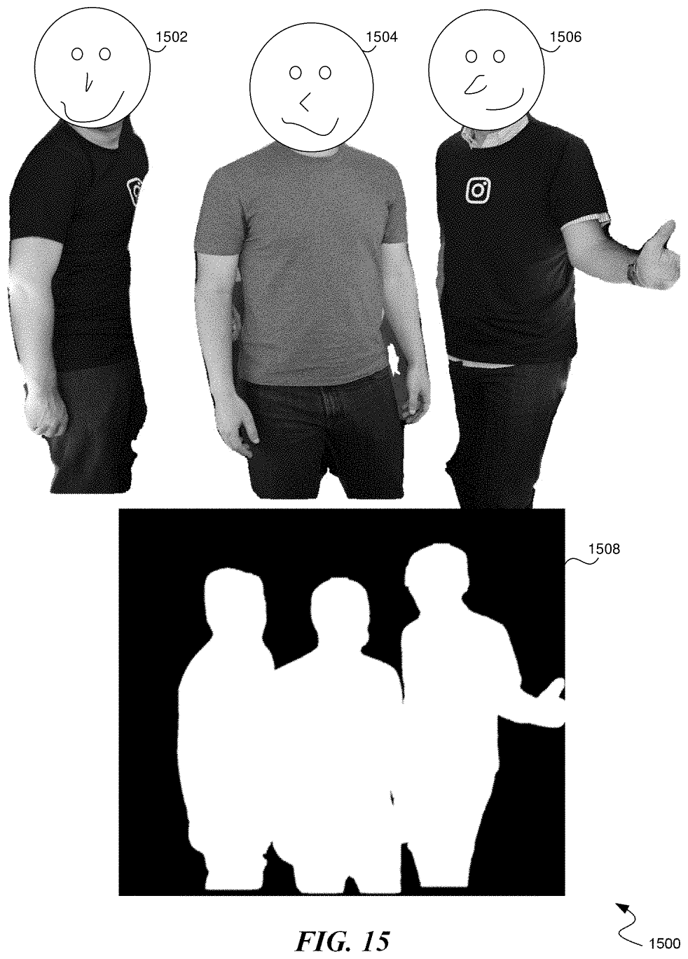

FIG. 15 illustrates an example 1500 of the results of segmenting an image into foreground and background elements (e.g., as described in relation to block 1404). In example 1500, a machine learning model has segmented an input image into the foreground entities 1502-1506 and identified a mask 1508 for the background of the input image. Using these segments and background mask, the automated effects engine can map the segments into the 3D space and define the virtual camera path for creating the flythrough video effect.

An automated editing engine can allow a user to select, through a single selection, an element appearing across multiple frames of a source video and replace the element in the source video with an alternate visual effect, thereby creating a transform video. The automated editing engine can identify replaceable elements across the source video that the user can chose among, or the automated editing engine can identify a particular replaceable element in relation to a selection (e.g., where a user clicks). The automated editing engine can identify the selected replaceable element throughout the source video—either having identified multiple replaceable elements throughout the source video prior to the user selection (e.g., with an object identification machine learning model) and identify the particular one once the user's selection is made or, once a replaceable element is selected, applying the machine learning model to identify other instances of that replaceable element throughout the source video.

The user can also supply one of various types of visual effects to replace the selected replacement element, such as a video, image, color, pattern, etc. In various implementations where the visual effect is a content item such as an image or video, the automated editing engine may modify the visual effect, such as enlarging it, to either make it able to cover the area of the selected replacement element or to match the dimensions of the source video. The automated editing engine can then mask each frame of the source video where the replaceable element is shown to replace it with the visual effect.

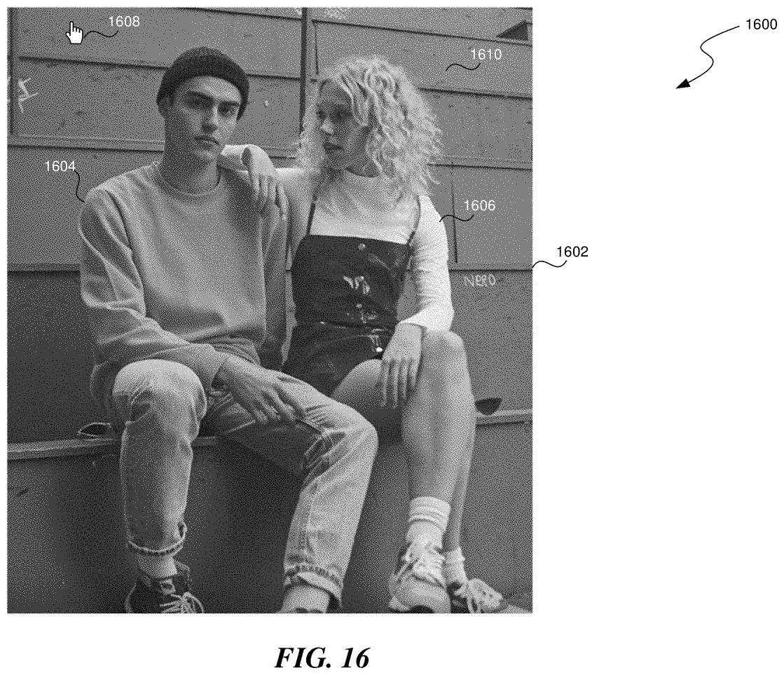

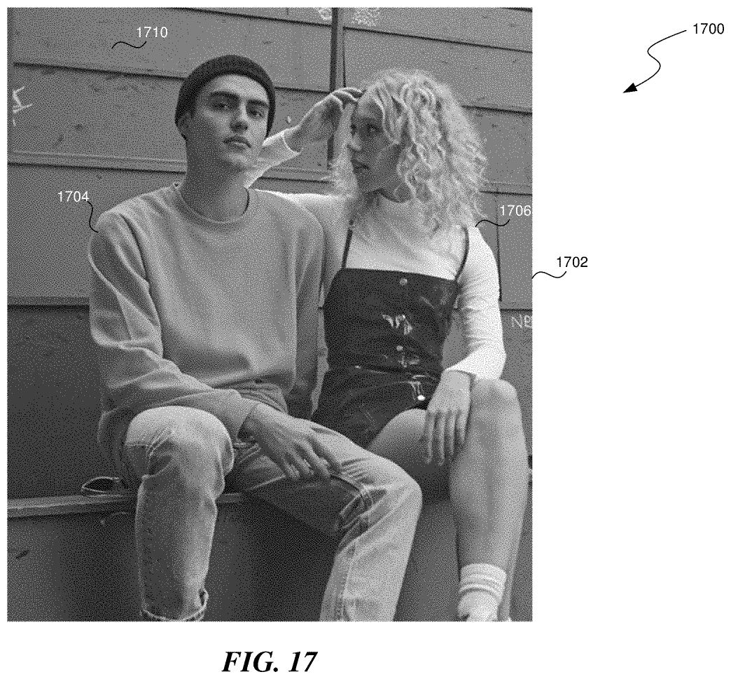

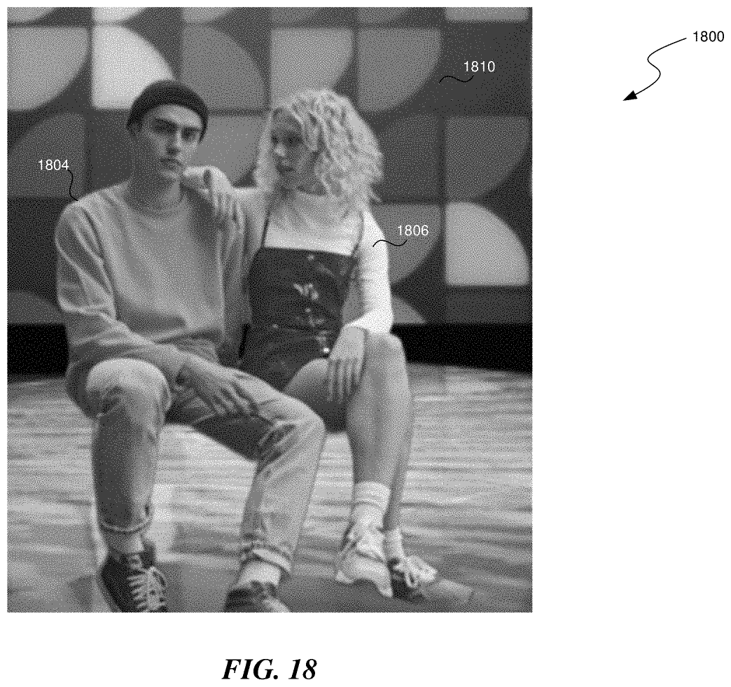

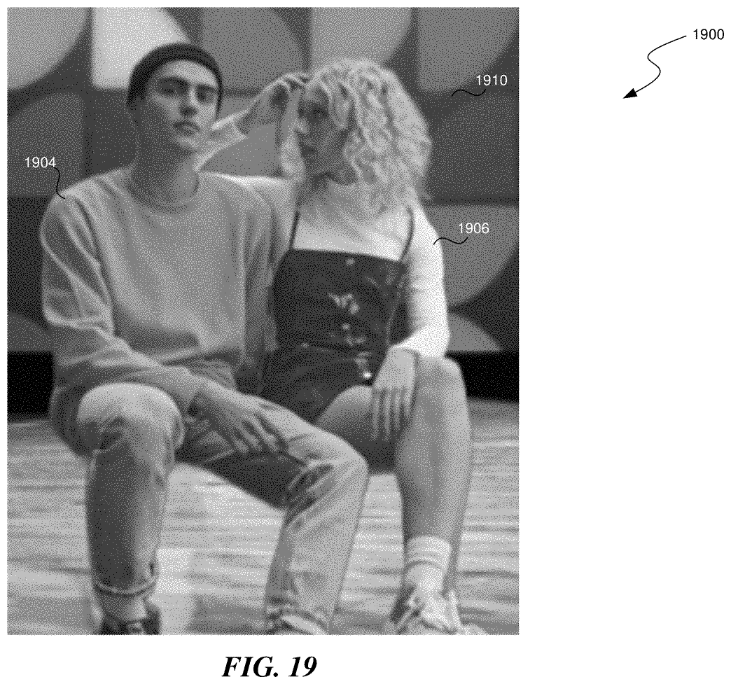

FIGS. 16-4 illustrate a first example of creating a transform video that replaces a background portion of a video with an alternate visual effect. Starting at 1600 in FIG. 16, the first example illustrates a frame of a source video 1602, depicting people elements 1604 and 1606 and a background element 1610. A user selects the background element 1610 by clicking it as shown at 1608. The automated editing engine searches through each frame, such as frame 1702 in 1700 of FIG. 17, of the source video and identifies the selected background element, such as the version 1710 of the background, excluding the people elements 1704 and 1706. The user then provides an image as a replacement visual effect which the automated editing engine resizes to be the same dimensions as the source video (not shown). Finally, the automated editing engine overlays the source video on the resized image and masks the source video to cut out the background portions in each frame. Thus, as illustrated in 1800 and 1900 of FIGS. 18 and 19, the overlay and masking allow the replacement image (1810 and 1910) to be seen in these places instead of the background, while keeping the unmasked portions (showing people 1804 and 1806 in FIGS. 18 and 1904 and 1906 in FIG. 19) to remain unchanged.

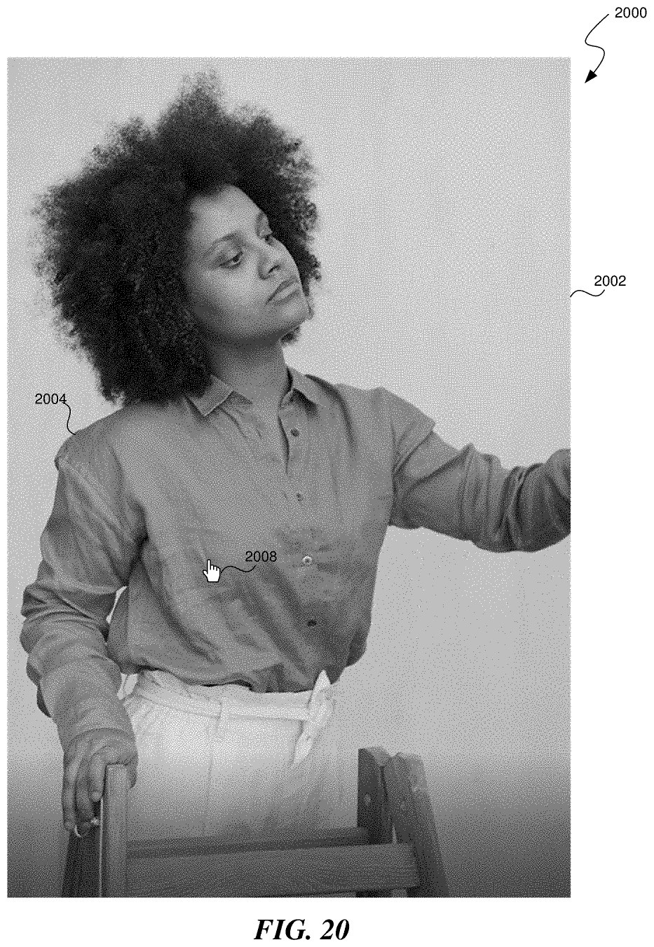

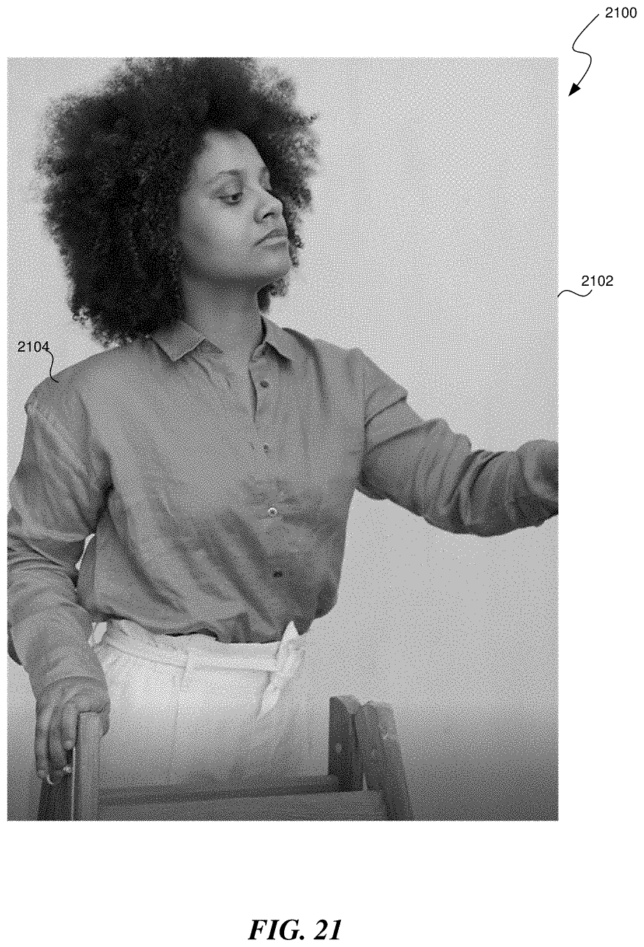

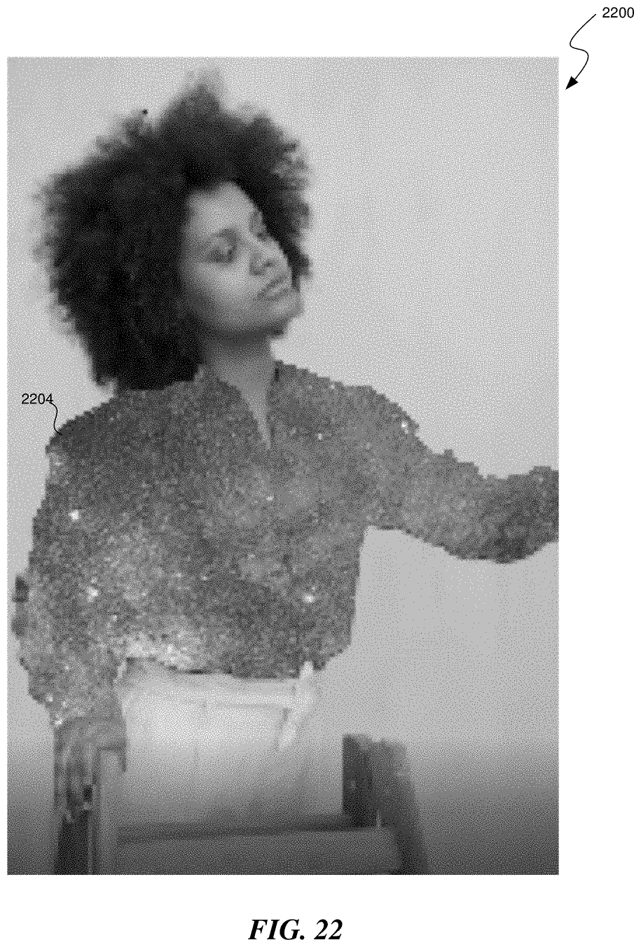

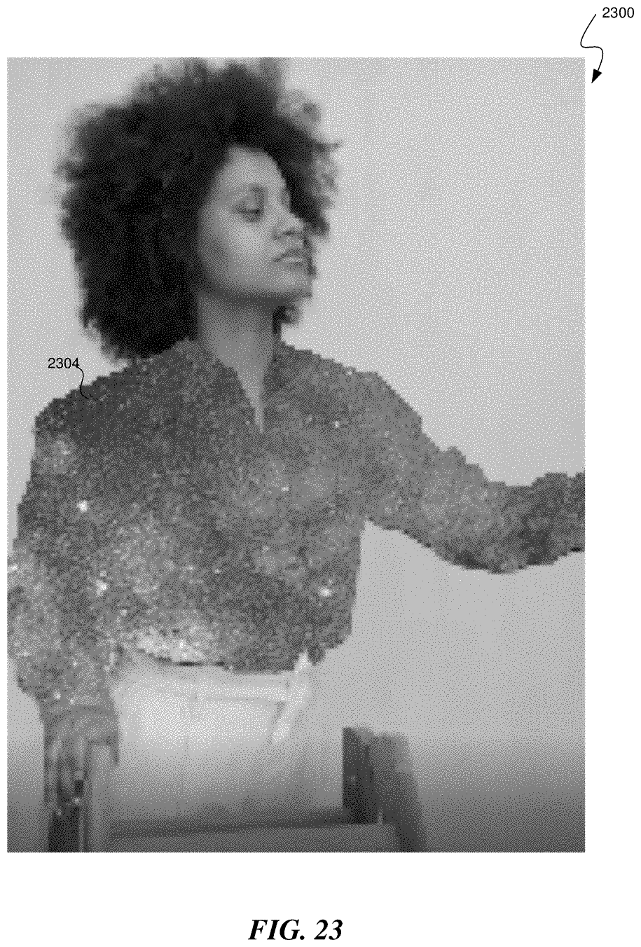

FIGS. 20-23 illustrate a second example of creating a transform video that replaces an article of clothing portion of a video with an alternate visual effect. Starting at 2000 in FIG. 20, the second example illustrates a frame of a source video 2002, depicting a person identified to have various articles of clothing, such as shirt 2004. A user selects the shirt element 2004 by clicking it as shown at 2008. The automated editing engine searches through each frame, such as frame 2102 in 2100 of FIG. 21, of the source video and identifies the selected shirt element, such as the version 2104. The user then provides an image as a replacement visual effect which the automated editing engine resizes for each frame to cover the area of the shirt element in that frame (not shown). Finally, the automated editing engine overlays the source video on the resized images, such that the image is aligned with the shirt element in each frame, and masks the source video to cut out the shirt element in each frame. Thus, as illustrated in 2200 and 2300 of FIGS. 22 and 23, the overlay and masking allow the image (2204 and 2304) to be seen in these places instead of the original shirt element, while keeping the unmasked portions unchanged.

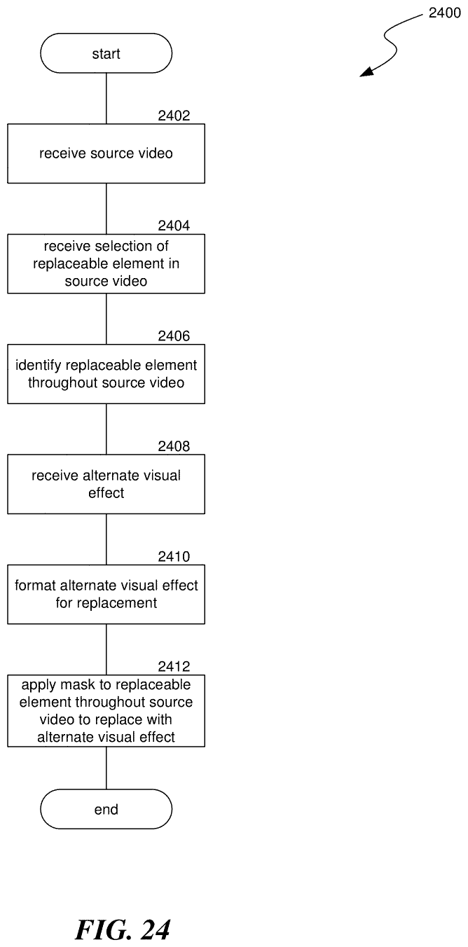

FIG. 24 is a flow diagram illustrating a process 2400 used in some implementations for creating a transform video that replaces portions of a video with an alternate visual effect. At block 2402, process 2400 can receive a source video. For example, a user can supply a video or a URL from which process 2400 can obtain the video. In some cases, the source video can be a segment of a longer provided video. For example, a user can supply a video and specify the source video as seconds 2-7 of the given video.

At block 2404, process 2400 can receive a selection of a replaceable element in the source video. In some implementations, process 2400 can have previously identified selectable elements in a current video frame or throughout the video and the user can choose from among these, e.g., by clicking on one, selecting from a list, etc. In other implementations, a user can first select a point or area of a current video frame and process 2400 can identify an element corresponding to the selected point or area. Process 2400 can identify elements at a particular point or area or throughout a video by applying a machine learning model trained to identify elements (e.g., people, objects, contiguous sections such as a background area, articles of clothing, body parts, etc.) In some cases, a user may specify an element selection drill level. For example, both an element of a person and an element of that person's shirt can be identified when the user clicks on the area of the video containing the shirt, she can have the option to drill up the selection to select the broader person element or down to select just the shirt element.

At block 2406, process 2400 can identify the replaceable element throughout the source video. This can include traversing the frames of the source video and applying a machine learning model (trained to label elements) to each to find elements that match the selected replaceable element. If the selected replaceable element was already identified throughout the source video, block 2406 can include selecting each instance of the selected replaceable element throughout the source video.

At block 2408, process 2400 can receive an alternate visual effect. This can include a user providing, e.g., alternate image or video (or a link to such an image or video), selecting a color or pattern, defining a morph function or other AR effect, etc.

At block 2410, process 2400 can format the alternate visual effect for replacement in the source video. In some cases, this can include resizing the visual effect to either match the size of the source video or to cover the size of the selected replaceable element. In other cases, this can include other adjustments for the alternate visual effect to match the selected replaceable element. For example, the alternate visual effect may be a makeup pattern to be applied to a user's face and formatting it can include mapping portions to the corresponding portions of the selected person element's face. As another example, the alternate visual effect may be an article of clothing to be applied to a user and formatting it can include mapping portions to the corresponding body parts of the selected person element.

At block 2412, process 2400 can apply a mask to the selected replaceable element throughout the source video to replace it with the alternate visual effect. For example, the source video can be overlaid on the alternate visual effect and the mask can cause that portion of the source vide to be transparent, showing the alternate visual effect in the masked area. As another example, the mask can be an overlay of the alternate visual on portions of the source video. In some cases, instead of replacing the masked portion of the source video with the alternate visual effect, the alternate visual effect can provide an augmentation to the source video, such as by adding a partially transparent color shading or applying a makeup effect through which the viewer can still see the underlying source video.

An automated effects engine can create a switch video by automatically splicing together portions of multiple source videos according to where frames in the source videos are most similar. In some implementations, a user can select a breakpoint in a first source video and the automated effects engine can determine which frame in another source video is most similar for making a transition. In other implementations, the automated effects engine can cycle through the source videos (two or more), specifying a breakpoint after a set amount of time (e.g., 1 second) from a marker, and locating, in the next source video, a start point to switch to, based on a match to the frame at the set breakpoint in the previous video. In yet a further implementation, the breakpoint can be set based on a context of frames in the source video, such as characteristics of the associated music (e.g., on downbeats).

For any given breakpoint frame (i.e., the frame at the breakpoint), the automated effects engine can determine a best matching frame in one or more other source videos by applying a machine learning model trained to determine a match between source videos or by determining an entity (e.g., person, object, etc.) position and pose in the breakpoint frame and locating a frame in another source video with a matching entity having a matching position and pose, where a match can be a threshold level of sameness or the located frame that is closest in position and pose. When a match is found, the automated effects engine can splice the previous source video to the next source video at the matching frame. In some cases, the switch video can include a single switch. In other cases, as the automated effects engine identifies additional breakpoints and matches, the automated effects engine can create the switch video having multiple switches across more than two source videos.

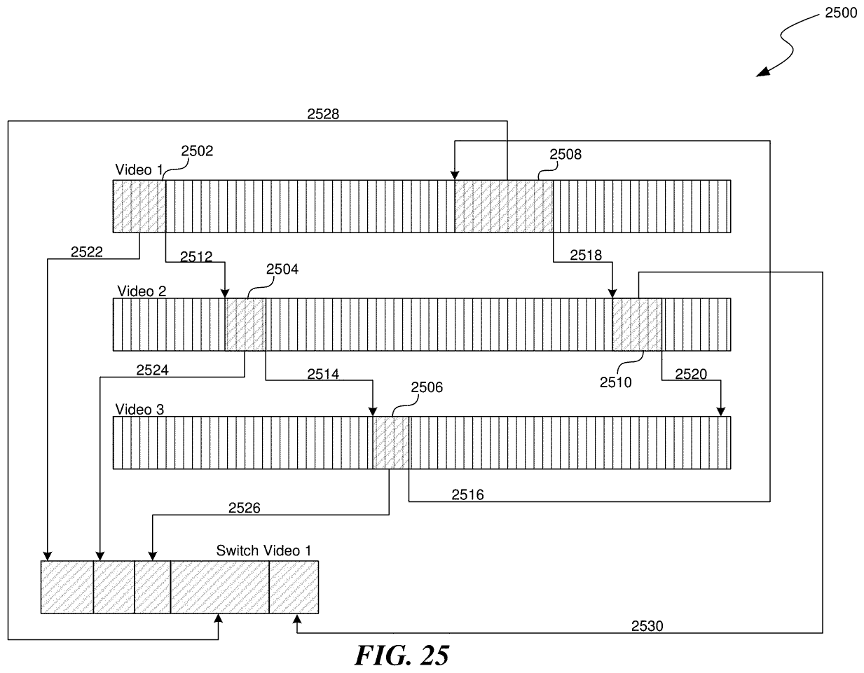

FIG. 25 is a conceptual diagram illustrating an example 2500 of the process for generating a switch video by automatically matching frames between multiple source videos. Example 2500 illustrates three source videos (video 1, video 2, and video 3) which are being spliced together into a switch video 1. Example 2500 starts with video 1 where the automated effects engine determines a breakpoint from the start of video 1 to a breakpoint at the end of section 2502. In example 2500, breakpoints are determined based on determined locations of corresponding downbeats in music (not shown). Section 2502 is added, at 2522, to the switch video 1 and the automated effects engine locates a frame in video 2 that matches the breakpoint frame at the end of the section 2502. That match is determined, at 2512, to be at frame at the beginning of section 2504, thus the beginning of section 2504 is selected as the beginning of a next clip for the switch video 1. This process is repeated, as described in the following paragraph, until all the sections 2504, 2506, 2508, and 2510 have also been added to the switch video 1.

Again based on downbeats in the corresponding music, the automated effects engine determines a breakpoint at the end of section 2504. The automated effects engine adds section 2504, at 2524, to the switch video 1 and the automated effects engine locates a frame in video 3 that matches the breakpoint frame at the end of the section 2504. That match is determined, at 2514, to be at frame at the beginning of section 2506, thus the beginning of section 2506 is selected as the beginning of a next clip for the switch video 1. Again based on downbeats in the corresponding music, the automated effects engine determines a breakpoint at the end of section 2506. The automated effects engine adds section 2506, at 2526, to the switch video 1 and the automated effects engine locates a frame in video 1 that matches the breakpoint frame at the end of the section 2506. That match is determined, at 2516, to be at frame at the beginning of section 2508, thus the beginning of section 2508 is selected as the beginning of a next clip for the switch video 1. Again based on downbeats in the corresponding music, the automated effects engine determines a breakpoint at the end of section 2508. The automated effects engine adds section 2508, at 2528, to the switch video 1 and the automated effects engine locates a frame in video 2 that matches the breakpoint frame at the end of the section 2508. That match is determined, at 2518, to be at frame at the beginning of section 2510, thus the beginning of section 2510 is selected as the beginning of a next clip for the switch video 1. Again based on downbeats in the corresponding music, the automated effects engine determines a breakpoint at the end of section 2510. The automated effects engine adds section 2510, at 2530, to the switch video 1 and the automated effects engine attempts to locate a frame in video 3 that matches the breakpoint frame at the end of the section 2510. However, at 2520, the automated effects engine determines that there is not enough time left in video 3 for another breakpoint. Thus, the automated effects engine determines that the creation of the switch video 25 is complete.

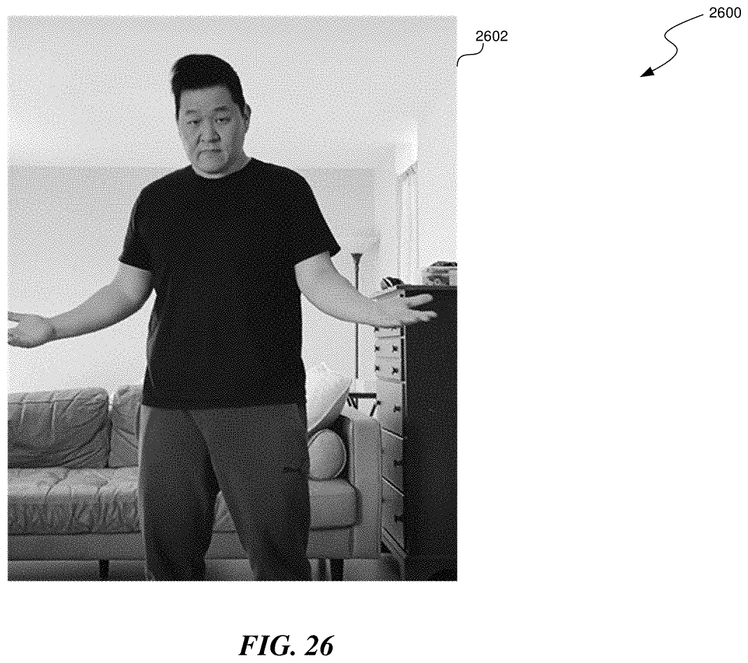

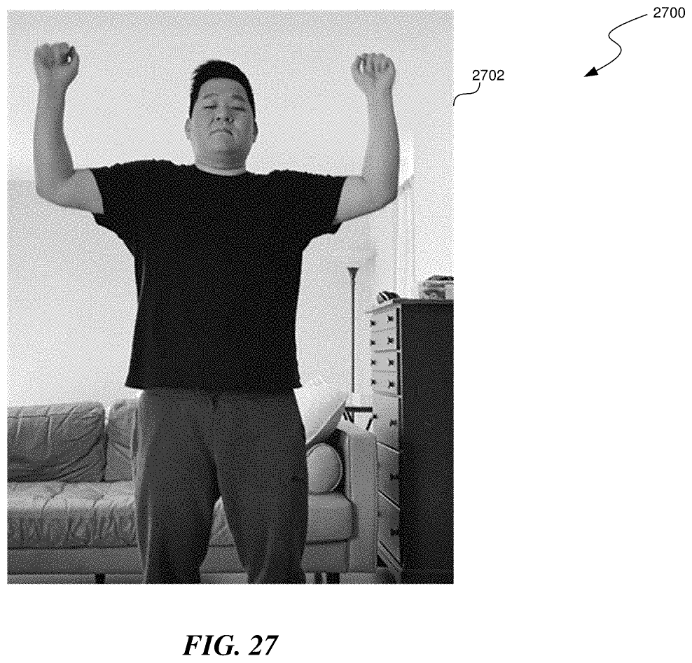

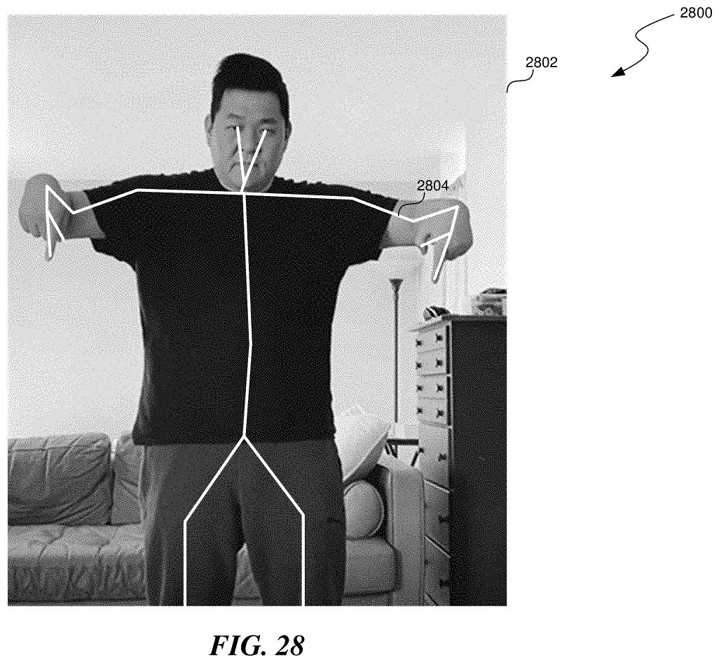

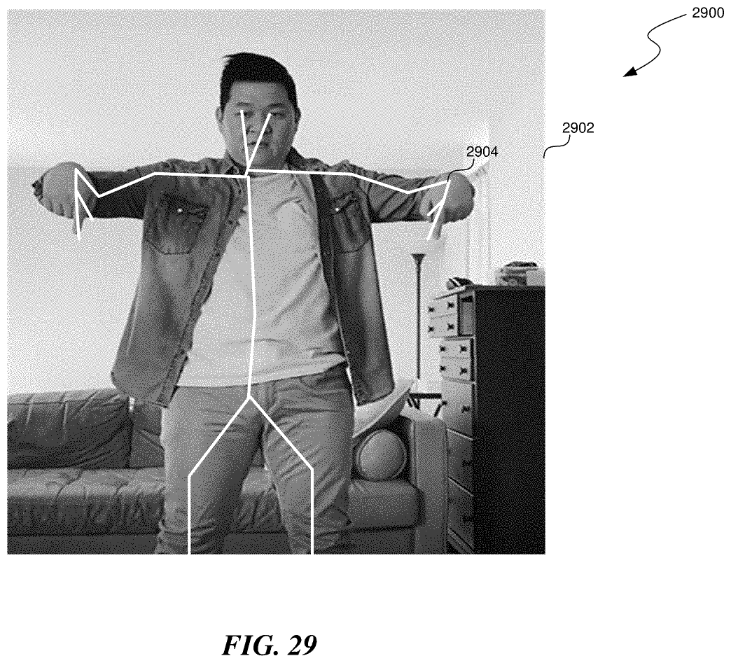

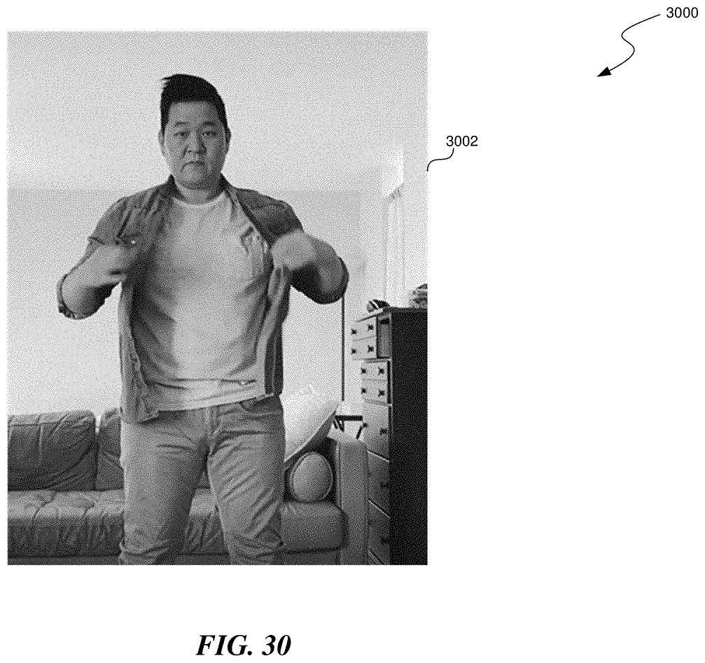

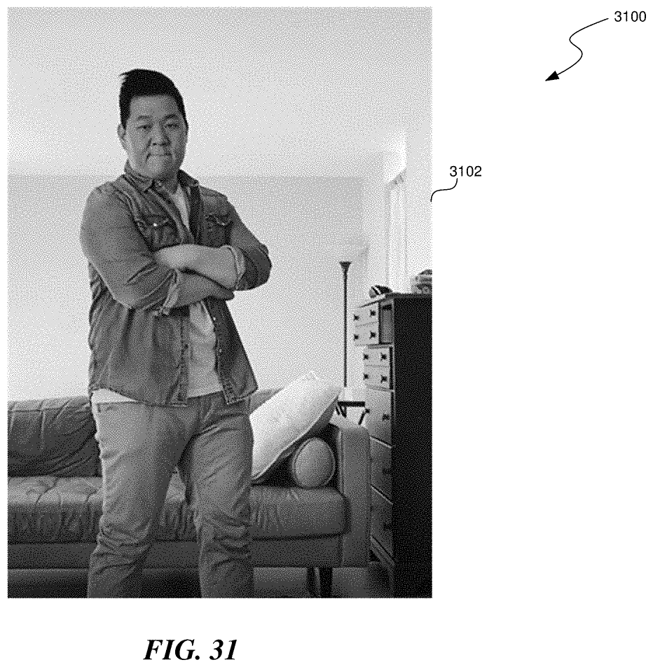

FIGS. 26-7 illustrate an example, covering 2600-700, of a switch video by showing multiple matched frames of the switch video. At 2600, a first frame 2602 from a first source video is illustrated and at 2700, a second frame 2702 from the first source video is illustrated. At 2800, a third frame 2802 from the first source video is illustrated, where this frame has been selected as a breakpoint frame. In response to this breakpoint frame selection, the automated effects engine has analyzed the person depicted in the frame 2802 to determine a kinematic model 2804 of the depicted user (which would not be shown in the resulting switch video). At 2900, the automated effects engine has analyzed frames of a second source video to determine kinematic models, for each frame, of a person corresponding to the person depicted in the first source video and the automated effects engine has determined that kinematic model 2904, illustrated over frame 2902, is the best match to kinematic model 2804. At 3000, a third frame 3002 from the second first source video, following frame 2902, is illustrated and at 3100, a third frame 3102 from the second source video, following frame 3002, is illustrated. Thus, the automated effects engine generates the switch video comprising the first source video up to frame 2802 and comprising the second source video from frame 2902 onward.

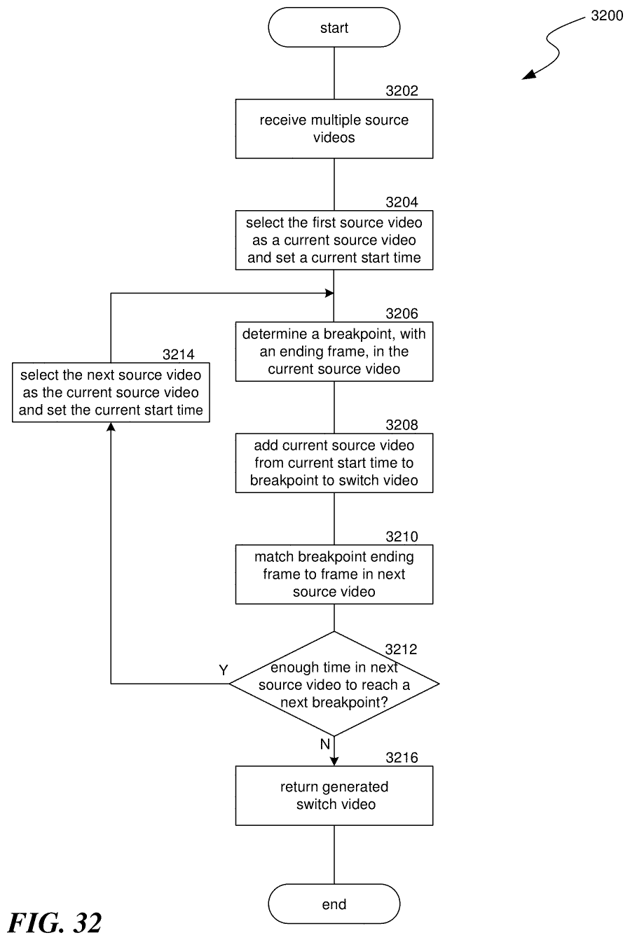

FIG. 32 is a flow diagram illustrating a process 3200 used in some implementations for generating a switch video by stitching together portions of multiple source videos at automatically matched frames. At block 3202, process 3200 can receive multiple source videos. For example, a user can supply two or more source videos or URLs from which process 3200 can retrieve source videos.

At block 3204, process 3200 can select the first source video as a current source video. Process 3200 can also set as a current start time at the beginning of the first source video. As the loop between blocks 3206-3214 progresses, the current source video will iterate through the source videos, with an updated determined current start time.

At block 3206, process 3200 can determine a breakpoint, with an ending frame (i.e., a breakpoint frame), in the current source video. The ending frame is the frame at the breakpoint in the current source video. In various implementations, the breakpoint can be set A) at a user selected point, B) based on characteristics of music associated with the current source video or a track selected for the resulting switch video (e.g., on downbeats, changes in volume, according to a determined tempo, etc.), or C) according to a set amount of time from the current start time (e.g., 1, 2, or 3 seconds). At block 3208, process 3200 can add to the switch video the current source video from the current start time to the breakpoint.

At block 3210, process 3200 can match the ending frame from the current source video (determined at block 3206) to a frame in a next source video. The next source video can be a next source video in a list of the source videos or process 3200 can analyze each of the other source videos to determine which has a best matching frame to the ending frame from current source video. In some cases, process 3200 can compare frames to determine a match score by applying a machine learning model trained to match video frames. In other cases, process 3200 can compare frames to determine a match score by modeling entities' (e.g., people or other objects) position and/or pose (e.g., by generating a kinematic model of a person by identifying and connecting defined points on the person) that are depicted in each of the ending frame and a candidate frame from another source video. Process 3200 can determine a match when a match score is a above a threshold or by selecting the highest match score. In some implementations, instead of searching all the frames in potential next source videos, process 3200 can limit the search to a maximum time from the beginning or from a most recent selected frame in the next source video. This can prevent process 3200 from jumping to an ending of the next source video when a later frame has a slightly better match than an earlier matching frame.

At block 3212, process 3200 can determine whether there is enough time in the next source video to reach a next breakpoint (e.g., as would be determined at block 3206). In some cases, where there is not enough time in the next source video, process 3200 can select a different next source video with a match (as determined by block 3210) to the ending frame. In other cases, or in cases where there is no such other next source video with a matching frame, process 3200 can continue to block 3216. If there is enough time in the next source video to reach a next breakpoint, process 3200 can continue to block 3214.

At block 3214, process 3200 can select the next source video as the current source video and can set the time of the frame determined, at block 3210, to match the breakpoint as the current start time. Process 3200 can then continue the loop between block 3206 and 3214 with the new current source video and current start time, to continue selecting segments of the switch video.

When process 3200 reaches block 3216, it has built (in the various iterations of block 3208) a switch video comprising two or more segments from two or more source videos. Process 3200 can then return the switch video generated in the various iterations of block 3208.

An audio effects system can allow a creator of audio based effects to define effects that control video rendering based on lyric content and lyric timing information, such as what portions of lyrics say (e.g., words or phrases), when those portions occur in the video, and for how long. In various implementations, creators can define effects that perform various actions in the rendering of a video based on a number defined lyric content and lyric timing values, defined at the lyric phrase and lyric word level, such as: lyricPhraseText (the text for a phrase of the lyrics), lyricPhraseLength: (a character count of a phrase in the lyrics), lyricPhraseProgress (an indicator, such as a scalar between 0-1, that reflects how far along in a phrase of the lyrics current playback is), lyricPhraseDuration (a total duration, e.g., in seconds, of a phrase of the lyrics), lyricWordText (the text for a word of the lyrics), lyricWordLength: (a character count of a word in the lyrics), lyricWordProgress (an indicator, such as a scalar between 0-1, that reflects how far along in a word of the lyrics current playback is), and lyricWordDuration (a total duration, e.g., in seconds, of a word of the lyrics).

Effects can be defined to accept any of these values, and in some cases other values defined for a video such as when and what type of beats are occurring, what objects and body parts are depicted in the video, tracked aspects of an environment in the video, meta-data associated with the video, etc., to control overlays or modifications in rendering the video. For example, the content (e.g., textual version) of lyrics for a video can be displayed as an overlay upon detected events in the video, such as a certain object appearing or a person depicted in the video making a particular gesture. Thus, the audio effects system, in applying audio-based effects, can obtain a video and associated selected effects, can obtain the lyric content and timing data, and can render the video with the execution of the effects' logic to modify aspects of the video rendering.

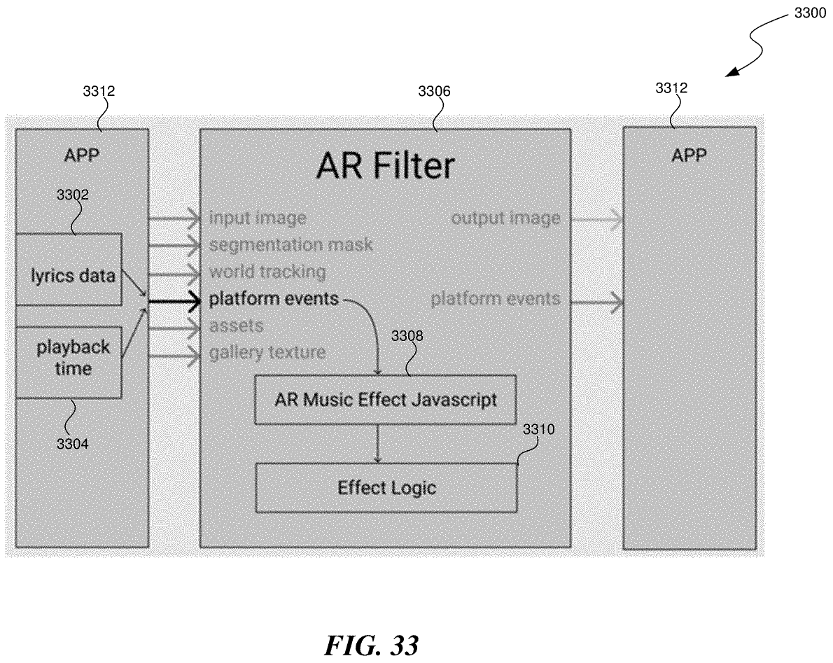

FIG. 33 is a system diagram of an audio effects system 3300. The audio effects system 3300 can receive lyrics data 3302 and a current playback time 3304 of a video being rendered in an application 3312. Based on which data items are needed by one or more effects selected for the current video, events such as a word or phrase in the lyrics starting, recognized gestures, beat characteristics, etc., can be provided to the effects (e.g., via a Javascript interface 3308) for execution of the effect's logic 3310. The results of the effect's logic execution on the video rendering process (e.g., adjusting output images) can be included in the output provided back to the application 3312 for display to a user.

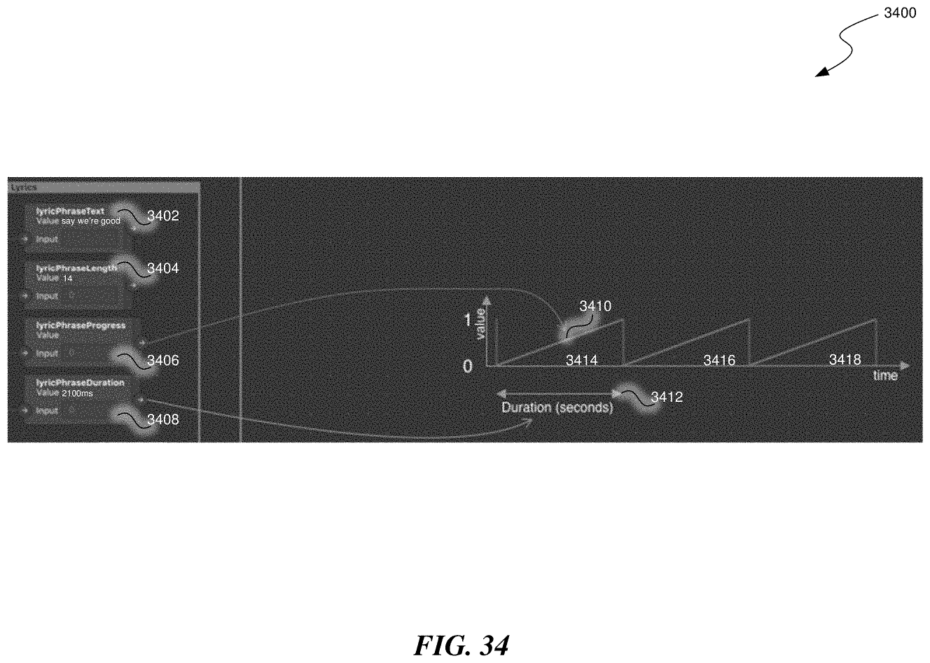

FIG. 34 is an example 3400 of lyric phrase data for the lyrics of an audio track. In example 3400, three phrases have been defined for a set of lyrics, each phrase corresponding to one of time segments 3414, 3416, and 3418. The variables for the lyric phrase in time segment 3414 are shown as elements 3402-3408. Variable lyricPhraseText 3402 can specify the text for a phrase of the lyrics—in this case “say we're good.” Variable lyricPhraseLength 3404 can specify a character count of the phrase in the lyrics—in this case 14 characters. Variable lyricPhraseProgress 3406 can specify an indicator, such as a scalar between 0-1, that reflects how far along a phrase of the lyrics current playback is—in this case shown by a pointer to location 3410 in the duration of the phrase. Variable lyricPhraseDuration 3408 can specify a total duration 3412, e.g., in milliseconds, of a phrase of the lyrics—in this case 2100 ms. In various implementations, these values can be manually specified for an audio track or determined automatically—e.g., through the application of speech recognition, parts-of-speech tagging, etc., technologies. In some implementations, a similar set of descriptors (not shown) are defined for each word in the lyrics.

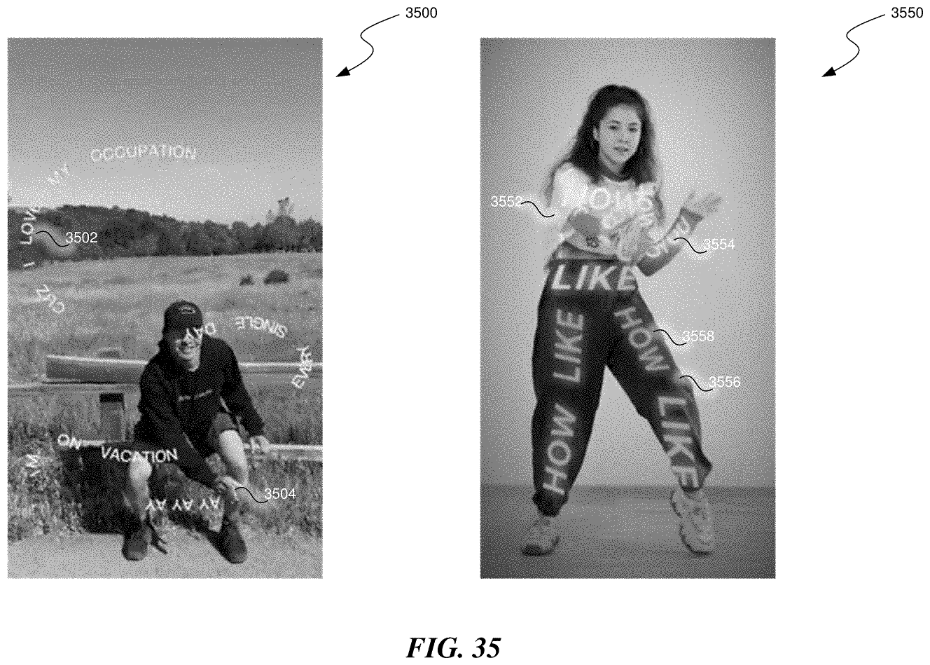

FIG. 35 illustrates examples 3500 and 3550 of videos rendered with audio effects based on lyric content and timing. In example 3500, the lyrics of a video, such as shown at 3502, are illustrated as an overlay on the video, shown at the same time each word is played in the corresponding audio track (and lingering for a specified amount of time), and positioned according to a current position of a tracked user's hand 3504 depicted in the video. In example 3550, a mask is determined for the torso 3552 of a depicted person and a mask for the lower portion 3556 of the depicted person. The lyrics of the video, such as shown at 3554 and 3558, are illustrated as an overlay on the video, shown at the same time each phrase is played in the corresponding audio track (and lingering until space is needed for a next phrase), and positioned according to the defined masks.

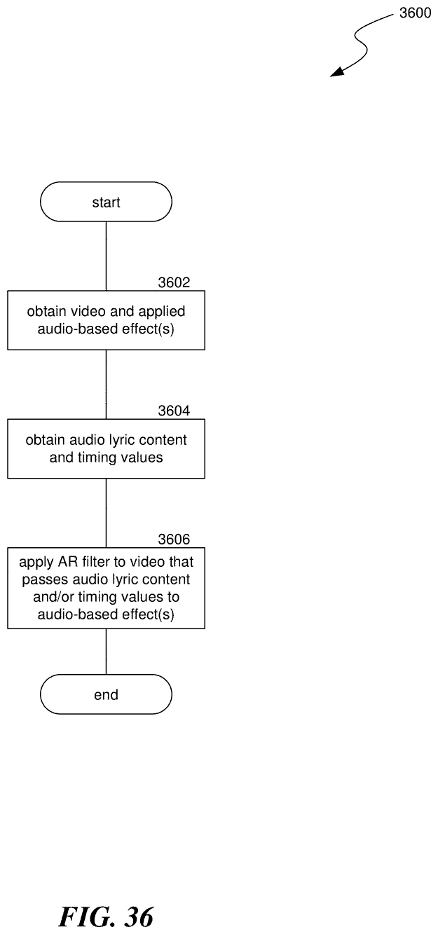

FIG. 36 is a flow diagram illustrating a process 3600 used in some implementations for the deployment of automatic video effects that respond to lyric content and lyric timing values for audio associated with a video. In various implementations, process 3600 can be performed on a client device or server system that can obtain both video data and applied effects. In some implementations, process 3600 may be performed ahead of viewing of the video to create a static video with applied audio effects, while in other implementations, process 3600 can be performed just-in-time in the rendering pipeline before viewing of a video, dynamically applying audio effects just before the resulting video stream is viewed.

At block 3602, process 3600 can obtain a video and one or more applied audio-based effects. The video can be a user-supplied video with its own audio track or an audio track selected from a library of tracks, which may have pre-defined lyric content and timing values. In some cases, the video can be analyzed to apply additional semantic tags, such as: masks for where body parts are and segmenting of foreground and background portions, object and surface identification, people identification, user gesture recognition, environment conditions, beat determinations, etc. The obtained effects can each include an interface specifying which lyric and other content and timing information the logic of that effect needs. Effect creators can define these effects specifying how they apply overlays, warping effects, color switching, or any other type of video effect with parameters based on the supplied information. For example, an effect can cause the current phrase from the lyrics to be obtained, have various font and formatting applied, and then displayed in the video as an overlay on an identified background portion of the video, causing the lyrics to appear as if behind a person depicted in the video.

At block 3604, process 3600 can obtain audio lyric content and timing values for the audio track associated with the obtained video. In some cases, the lyric content and timing values can be pre-defined for the audio track of the obtained video, e.g., where the audio track was selected from a library with defined lyric data. In other implementations, the lyric content and timing values can be generated dynamically for provided audio, e.g., by applying existing speech-to-text technologies, identifying phrases from sets of words (e.g., with existing parts-of-speech tagging technologies), and mapping the timing of determined words and phrases for the provided audio.

In various implementations, lyric content and timing values can be defined at the lyric phrase and lyric word level, such as: lyricPhraseText (the text for a phrase of the lyrics), lyricPhraseLength: (a character count of a phrase in the lyrics), lyricPhraseProgress (an indicator, such as a scalar between 0-1, that reflects how far along a phrase of the lyrics current playback is), lyricPhraseDuration (a total duration, e.g., in seconds, of a phrase of the lyrics), lyricWordText (the text for a word of the lyrics), lyricWordLength: (a character count of a word in the lyrics), lyricWordProgress (an indicator, such as a scalar between 0-1, that reflects how far along a word of the lyrics current playback is), and lyricWordDuration (a total duration, e.g., in seconds, of a word of the lyrics).

At block 3606, process 3600 can apply an AR filter, to the video rendering process, that passes audio lyric content and/or timing values to the one or more audio-based effects, for the corresponding effect's logic to execute and update video rendering output. The audio lyric content and/or timing values (and other video data, such as tracked objects, body positioning, foreground/background segmentation, etc.) that is supplied to each effect can be based on an interface defined for that effect specifying the data needed for the effect's logic. In some cases, the effects can further use beat timing values, as discussed in related U.S. Provisional Patent Application, titled Beat Reactive Video Effects, filed herewith, and with Attorney Docket No. 3589-0088DP01, which is incorporated above by reference in its entirety. This data can be supplied to the effect on a periodic basis (e.g., once per video frame, once per 10 milliseconds of the video, etc.) or based on events for which the effect has been registered (e.g., the effect can have a triggering condition that activates the effect upon process 3600 recognizing a depicted person's action or spoken phrase). Following the application of the effect(s) to the video rendering, process 3600 can end.

An audio effects system can allow a creator of audio based effects to define effects that control video rendering based on beat information, such as when different types of beats occur, for how long, and how far along video playback is into a particular beat. In various implementations, beats can be then grouped into categories such as strong beats, down beats, phrase beats, or two bar beats. For each beat, the audio effects system can specify variables such as: beatType (the type of the beat), beatProgress (an indicator, such as a scalar between 0-1, that reflects how far along in a beat current playback is), and beatDuration (a total duration, e.g., in seconds, of the beat). A beatWave variable can also be defined for the video's audio track, which can include various wave forms, such as a triangular wave, square wave, sinusoidal, etc., with values between 0-1 that peaks on the beat and goes to zero at the halfway point between beats.

Effects can be defined to accept any of these values, and in some cases other values defined for a video such as the content and timing of lyrics in the audio track, what objects and body parts are depicted in the video, tracked aspects of an environment in the video, meta-data associated with the video, etc., to control overlays or modifications in rendering the video. For example, when a user makes a particular gesture (such as putting one arm over her head) the audio effects system can begin strobing the video to blur and color shift on each down beat. Thus, the audio effects system, in applying audio-based effects, can obtain a video and associated selected effects, can obtain the beat type and timing data, and can render the video with the execution of the effects' logic to modify aspects of the video rendering.

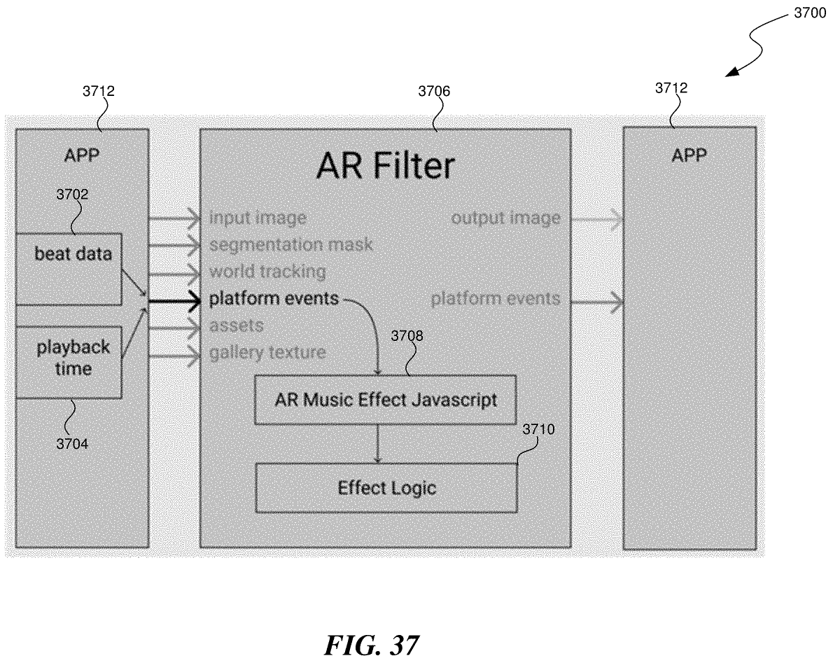

FIG. 37 is a system diagram of an audio effects system 3700. The audio effects system 3700 can receive beat data 3702 and a current playback time 3704 of a video being rendered in an application 3712. Based on which data items are needed by one or more effects selected for the current video, events such as beats occurring, recognized gestures, lyric content and timing, etc., can be provided to the effects (e.g., via a Javascript interface 3708) for execution of the effect's logic 3710. The results of the effect's logic execution on the video rendering process (e.g., adjusting output images) can be included in the output provided back to the application 3712 for display to a user.

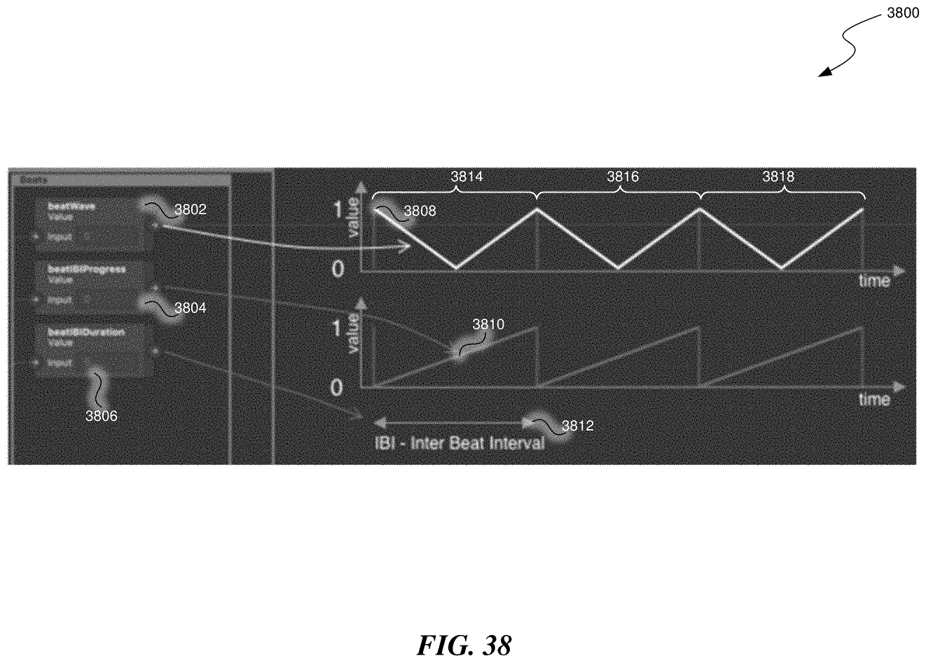

FIG. 38 is an example 3800 of lyric phrase data for the lyrics of an audio track. In example 3800, three beats have been identified for the displayed portion of the audio track, each beat corresponding to one of time segments 3814, 3816, and 3818. The variables for the beat in time segment 3814 are shown as elements 3802-3806. Variable beatWave 3802 can specify a wave form, such as a triangular wave, square wave, sinusoidal, etc., with values in a range, such as between 0-1 that peaks on the beat (e.g., at point 3808 for the beat in timeframe 3814) and goes to zero at the halfway point between beats. Variable beatBIProgress 3804 can specify an indicator, such as a scalar between 0-1, that reflects how far along current playback is through the beat—in this case shown by a pointer to location 3810 in the duration of the phrase. Variable beatBIDuration 3806 can specify a total duration 3812, e.g., in milliseconds, of the beat. In various implementations, these values can be manually specified for an audio track or determined automatically—e.g., through the application of machine learning models trained to identify beat types or algorithmic processes that analyze beats according to beat templates to determine the beat type, where once a section of an audio track is identified as a beat type, it can also be associated with timing data.

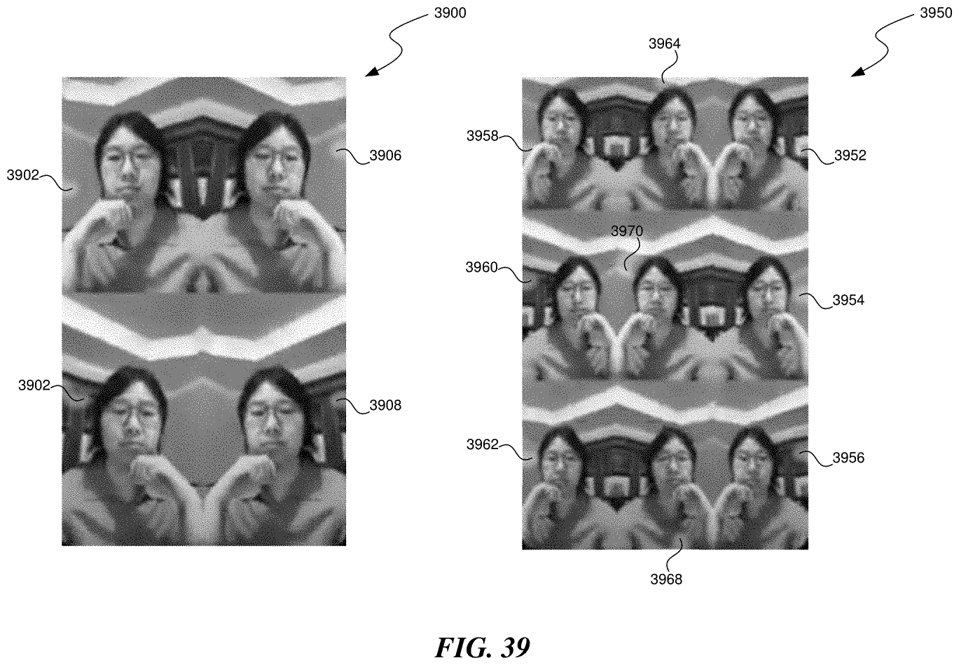

FIG. 39 illustrates examples 3900 and 3950 of a video rendered with an audio effect based on beat timing. In examples 3900 and 3950, a user selected an effect to begin at a certain time in a video where the effect multiplies the current video frame upon each strong beat. Example 3900 illustrates the effect applied in response to the first strong beat, where the video frame has been duplicated into images 3902-3908. Example 3950 illustrates the effect applied in response to the second strong beat, where the video frame has been further duplicated into images 3952-3970.

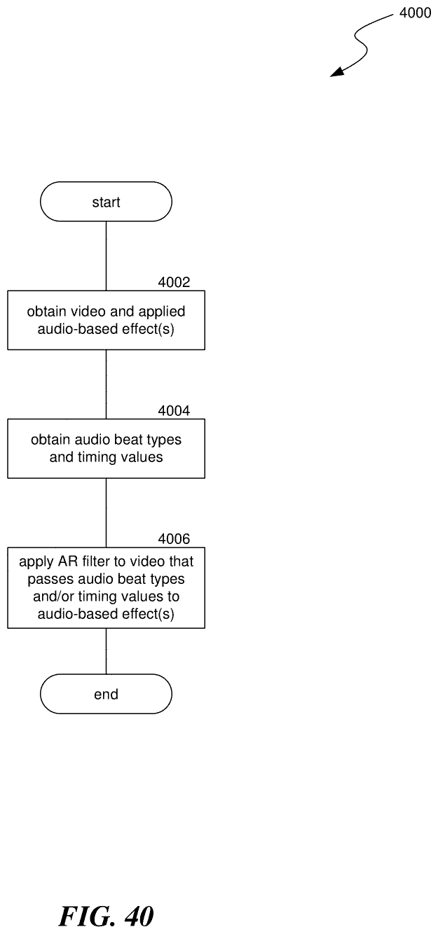

FIG. 40 is a flow diagram illustrating a process 4000 used in some implementations for the deployment of automatic video effects that respond to beat type and timing values for audio associated with a video. In various implementations, process 4000 can be performed on a client device or server system that can obtain both video data and applied effects. In some implementations, process 4000 may be performed ahead of viewing of the video to create a static video with applied audio effects, while in other implementations, process 4000 can be performed just-in-time in the rendering pipeline before viewing of a video, dynamically applying audio effects just before the resulting video stream is viewed.

At block 4002, process 4000 can obtain a video and one or more applied audio-based effects. The video can be a user-supplied video with its own audio track, or an audio track selected from a library of tracks, which may have pre-defined beat type and timing values. In some cases, the video can be analyzed to apply additional semantic tags, such as: masks for where body parts are and segmenting of foreground and background portions, object and surface identification, people identification, user gesture recognition, environment conditions, lyric content and timing determinations, etc. The obtained effects can each include an interface specifying which beat and other content and timing information the logic of that effect needs. Effect creators can define these effects specifying how they apply overlays, warping effects, color switching, or any other type of video effect with parameters based on the supplied information. For example, an effect can render a video such that on each down beat the video is mirrored (i.e., flipped horizontally), on each strong beat the video zooms in on a person depicted in the video and determined to be in the video foreground, and on each non-strong beat the video zooms back out again.

At block 4004, process 4000 can obtain audio beat type and timing values for the audio track associated with the obtained video. In some cases, the beat type and timing values can be pre-defined for the audio track of the obtained video, e.g., where the audio track was selected from a library with defined beat data. In other implementations, the beat type and timing values can be generated dynamically for provided audio, e.g., by a machine learning model trained to identify beat types, which can be mapped to when they occur in an audio track. In various implementations, beat type values can include strong beats, down beats, phrase beats, or two bar beats. For each beat, the timing values can specify beatProgress (an indicator, such as a scalar between 0-1, that reflects how far along in a beat current playback is) and beatDuration (a total duration, e.g., in seconds, of the beat). A beatWave variable can also be defined for the video's audio track, which can include various wave forms, such as a triangular wave, square wave, sinusoidal, etc., with values in a range, such as between 0-1 that peaks on the beat and goes to zero at the halfway point between beats.

At block 4006, process 4000 can apply an AR filter, to the video rendering process, that passes audio beat type and/or timing values to the one or more audio-based effects, for the corresponding effect's logic to execute and update video rendering output. The audio beat type and/or timing values (and other video data, such as tracked objects, body positioning, foreground/background segmentation, etc.) that is supplied to each effect can be based on an interface defined for that effect specifying the data needed for the effect's logic. In some cases, the effects can further use lyric content and/or timing values, as discussed in related U.S. Provisional Patent Application, titled Lyric Reactive Video Effects, filed herewith, and with Attorney Docket No. 3589-0087DP01, which is incorporated above by reference in its entirety. This data can be supplied to the effect on a periodic basis (e.g., once per video frame, once per 10 milliseconds of the video, etc.) or based on events for which the effect has been registered (e.g., the effect can have a triggering condition that activates the effect upon process 4000 recognizing a depicted person's action or spoken phrase). Following the application of the effect(s) to the video rendering, process 4000 can end.

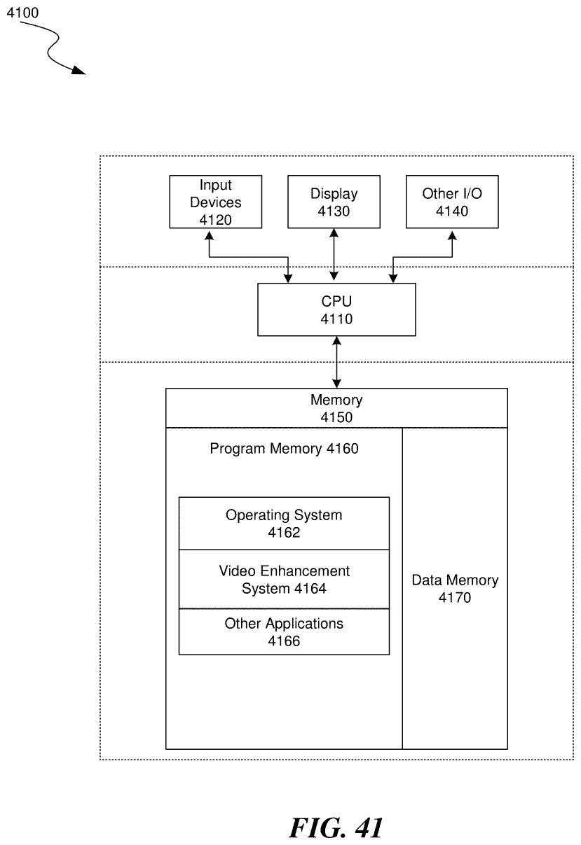

FIG. 41 is a block diagram illustrating an overview of devices on which some implementations of the disclosed technology can operate. The devices can comprise hardware components of a device 4100 that can perform various video enhancements. Device 4100 can include one or more input devices 4120 that provide input to the Processor(s) 4110 (e.g., CPU(s), GPU(s), HPU(s), etc.), notifying it of actions. The actions can be mediated by a hardware controller that interprets the signals received from the input device and communicates the information to the processors 4110 using a communication protocol. Input devices 4120 include, for example, a mouse, a keyboard, a touchscreen, an infrared sensor, a touchpad, a wearable input device, a camera- or image-based input device, a microphone, or other user input devices.

Processors 4110 can be a single processing unit or multiple processing units in a device or distributed across multiple devices. Processors 4110 can be coupled to other hardware devices, for example, with the use of a bus, such as a PCI bus or SCSI bus. The processors 4110 can communicate with a hardware controller for devices, such as for a display 4130. Display 4130 can be used to display text and graphics. In some implementations, display 4130 provides graphical and textual visual feedback to a user. In some implementations, display 4130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 4140 can also be coupled to the processor, such as a network card, video card, audio card, USB, firewire or other external device, camera, printer, speakers, CD-ROM drive, DVD drive, disk drive, or Blu-Ray device.

In some implementations, the device 4100 also includes a communication device capable of communicating wirelessly or wire-based with a network node. The communication device can communicate with another device or a server through a network using, for example, TCP/IP protocols. Device 4100 can utilize the communication device to distribute operations across multiple network devices.

The processors 4110 can have access to a memory 4150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 4150 can include program memory 4160 that stores programs and software, such as an operating system 4162, video enhancement system 4164, and other application programs 4166. Memory 4150 can also include data memory 4170, e.g., configuration data, settings, user options or preferences, etc., which can be provided to the program memory 4160 or any element of the device 4100.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

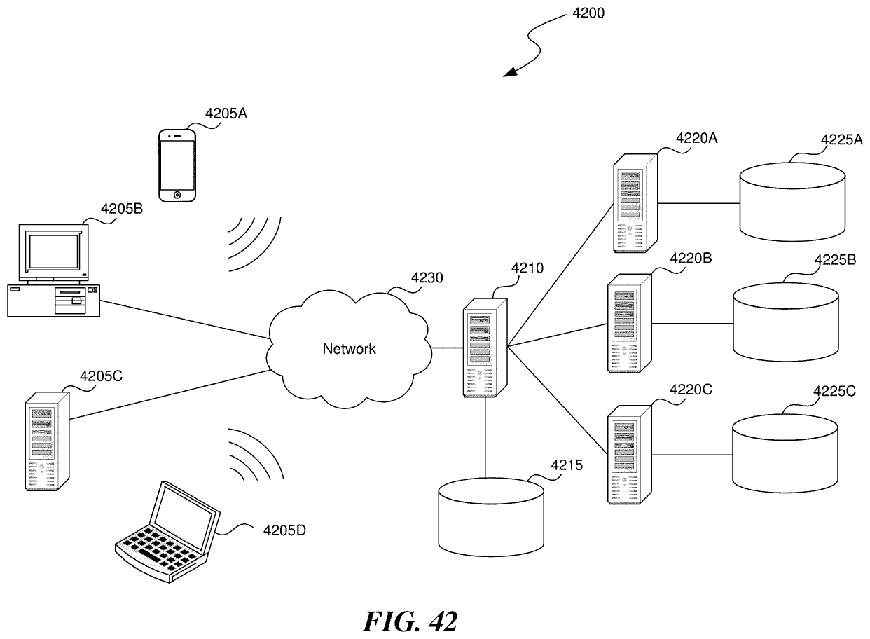

FIG. 42 is a block diagram illustrating an overview of an environment 4200 in which some implementations of the disclosed technology can operate. Environment 4200 can include one or more client computing devices 4205A-D, examples of which can include device 4100. Client computing devices 4205 can operate in a networked environment using logical connections through network 4230 to one or more remote computers, such as a server computing device.

In some implementations, server 4210 can be an edge server which receives client requests and coordinates fulfillment of those requests through other servers, such as servers 4220A-C. Server computing devices 4210 and 4220 can comprise computing systems, such as device 4100. Though each server computing device 4210 and 4220 is displayed logically as a single server, server computing devices can each be a distributed computing environment encompassing multiple computing devices located at the same or at geographically disparate physical locations. In some implementations, each server 4220 corresponds to a group of servers.

Client computing devices 4205 and server computing devices 4210 and 4220 can each act as a server or client to other server/client devices. Server 4210 can connect to a database 4215. Servers 4220A-C can each connect to a corresponding database 4225A-C. As discussed above, each server 4220 can correspond to a group of servers, and each of these servers can share a database or can have their own database. Databases 4215 and 4225 can warehouse (e.g., store) information. Though databases 4215 and 4225 are displayed logically as single units, databases 4215 and 4225 can each be a distributed computing environment encompassing multiple computing devices, can be located within their corresponding server, or can be located at the same or at geographically disparate physical locations.

Network 4230 can be a local area network (LAN) or a wide area network (WAN), but can also be other wired or wireless networks. Network 4230 may be the Internet or some other public or private network. Client computing devices 4205 can be connected to network 4230 through a network interface, such as by wired or wireless communication. While the connections between server 4210 and servers 4220 are shown as separate connections, these connections can be any kind of local, wide area, wired, or wireless network, including network 4230 or a separate public or private network.

In some implementations, servers 4210 and 4220 can be used as part of a social network. The social network can maintain a social graph and perform various actions based on the social graph, A social graph can include a set of nodes (representing social networking system objects, also known as social objects) interconnected by edges (representing interactions, activity, or relatedness), A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

The disclosed technology can include, for example, the following:

A method for spatially administering a video call, the method comprising: starting the video call with multiple participants; establishing virtual locations for one or more participants of the multiple participants; and spatially controlling the video call by: positioning the one or more participants in the video call according to the established virtual locations; or applying effects to video feeds of at least some of the one or more participants by evaluating one or more rules with the one or more virtual locations, of the at least some of the one or more participants, as parameters to the one or more rules.

A method for converting an image to a flythrough video, the method comprising: obtaining an image; segmenting the obtained image into a background segment and foreground segments; filling in gaps in the background segment; mapping the background and foreground segments into a 3D space; defining a path through the 3D space; and recording the flythrough video with a virtual camera that traverses the 3D space along the defined path.

A method for creating a transform video that replaces portions of a video with an alternate visual effect, the method comprising: receiving a source video; receiving a selection of a replaceable element in the source video; identifying the replaceable element throughout the source video; receiving an alternate visual effect; and replacing the replaceable element, throughout the source video, with the alternate visual effect.

I/We claim:

1. A method for stitching together portions of multiple source videos at automatically matched frames, the method comprising:
receiving the multiple source videos;
identifying one or more breakpoints, with an ending frame, in one or more of the multiple source videos;
for each particular breakpoint, of the one or more breakpoints, determining a frame in another of the multiple source videos that matches the ending frame of the particular breakpoint; and
building a switch video that switches, between segments of the source videos, from each ending frame of each breakpoint to the matched frame of the other source video.

2. A method for deployment of automatic video effects that respond to lyric content and/or lyric timing values for audio associated with a video, the method comprising:
obtaining video and one or more applied audio-based effects;
obtaining audio lyric content and timing values; and
applying an AR filter to the video that passes the audio lyric content and/or timing values to the one or more applied audio-based effects, wherein execution of logic of the one or more applied audio-based effects, based on the audio lyric content and/or timing values, modify a rendering of the video.

3. A method for deployment of automatic video effects that respond to beat type and/or beat timing values for audio associated with a video, the method comprising:
obtaining video and one or more applied audio-based effects;
obtaining audio beat type and timing values; and
applying an AR filter to the video that passes the audio beat type and/or timing values to the one or more applied audio-based effects, wherein execution of logic of the one or more applied audio-based effects, based on the audio beat type and/or timing values, modify a rendering of the video.
